(19) United States
(12) Patent Application Publication
(10) Pub. No.: US 2005/0090201 A1
(43) Pub. Date: Apr. 28, 2005

(54) System and method for a mobile AD HOC network suitable for aircraft

(76) Inventors: Mark Lengies, Kitchener (CA); Xiaoan Lu, Kitchener (CA); Patrick James Reid, Waterloo (CA)

Correspondence Address: BERESKIN AND PARR, 40 KING STREET WEST, BOX 401, TORONTO, ON, M5H 3Y2, CA

(21) Appl. No.: 10/921,794

(22) Filed: Aug. 20, 2004

(30) Foreign Application Priority Data
Aug. 20, 2003 (CA) 2,437,926

(51) Int. Cl. H04B 7/00

(52) U.S. Cl. 455/41.2; 455/431

(57) ABSTRACT

The present invention provides a wireless ad hoc network suitable for sharing data on a peer-to-peer basis between nodes, some of which may be aircraft, having a terminal device comprising a wireless communications transceiver, a sensor, and a computing device. Multiple hops between nodes maximize range of the network. In addition, architectures for terminal devices allow for use of a wide variety of wireless communications transceivers and sensors, without affecting applications that use the network. Such invention may include, among others, a fire fighting application allowing different aircraft to co-ordinate firefighting activities by using shared fire and positional data for aircraft.

This application claims the benefit under 35 U.S.C. 119(a) of Canadian Patent Application No. 2,437,926, filed Aug. 20, 2003.

### FIELD OF THE INVENTION

This invention relates to mobile wireless networking, and more particularly, to a system and method for a mobile wireless network suitable for sharing messages, including data, among aircraft.

### BACKGROUND OF THE INVENTION

Sharing data over computer networks between airborne vehicles, either on an air-to-air basis or air-to-ground basis is a relatively new idea. Currently, sharing of data and coordination of activities for airborne vehicles is often achieved through voice communication. However, such voice communication is often error prone, ambiguous, inaccurate, slow, and less effective for coordinating operations than by using computerized sharing of data. These disadvantages may cause safety hazards and poor operational effectiveness.

Since airborne vehicles rapidly change position, it is difficult for them to maintain in contact with any centralized server or architecture that provides network and routing services. However, wireless ad hoc network techniques allow for self-formation of networks and routing of wireless data network communications on a peer to peer basis between computing devices without any need for a fixed access point to the network or centralized server.

Ad hoc networks are known in the art. For example, United States Patent Application No. 2003/0060202 (Roberts) discloses a system and method for enabling a mobile user computing device in an ad-hoc wireless communications network to selectably operate as a router for other mobile user terminals in the network based on certain criteria. The computing device includes a transceiver adapted to transmit wireless communications data, such as packetized data, addressed to a destination user terminal and to at least one other user terminal for routing by that other user terminal to the destination user terminal. United States Patent Application No. 2003/0091011 (Roberts et al.) discloses a communications network that employs ad-hoc routing techniques during handoff of a wireless user terminal between access point nodes to a core network to enable the network to maintain multiple paths via which data packets are provided to the user terminal during handoff. Thus, the communications can efficiently handle mobility of wireless user terminals between access point nodes of a packet-switched network.

While ad hoc networks are known in the art, none of the current ad hoc systems address the unique context of providing network data communications between airborne vehicles. Given the high speeds of airborne vehicles, the distance between computing device nodes in the network will frequently change causing the computing device nodes to go out of range of one another resulting in frequent unexpected interruptions in the network. At the same time, since distances between airborne vehicles will change rapidly, the distance over which computing devices within the network must be maximized. Accordingly, it would be useful to provide a wireless peer to peer ad hoc network for sharing data between computing devices on different aircraft wherein the distance over which computing devices on different airborne vehicles can communicate with one another is maximized and which can recover gracefully when a computing device on an airborne vehicle goes out of range. Further, since the topology of a network for airborne vehicles will change rapidly, it would be advantageous that such a network be self-forming and self healing to allow for rapid addition and removal of new airborne vehicles having computing devices as nodes. Further, the high speeds of airborne vehicles and airborne operations imply that data shared between computing devices on airborne vehicles will rapidly become obsolete. Accordingly, it would also be useful if the data transmitted from one airborne vehicle to another airborne vehicle could be updated in real time.

### SUMMARY OF THE INVENTION

The present invention in one aspect provides a wireless communications system for communicating a data message comprising:
(a) a wireless data communication network for transmitting and receiving the data message;
(b) a source computing device, connected to said wireless data communication network, for generating the data message;
(c) a plurality of receiving computing devices connected to said wireless data communication network, said plurality of receiving computing devices further comprising a destination computing device, for receiving and further transmitting the data message until said destination computing device receives the data message; and
(d) software on each source and receiving computing device for managing the data message and said transmitting and said receiving; wherein at least two of said source computing device and said receiving computing devices are installed on vehicles, at least one of said vehicles being an airborne vehicle.

In another aspect, the present invention provides a method for wireless data communication of a data message comprising:
(a) generating the data message on a source computing device connected to a wireless data communication network comprising a plurality of wireless data transceivers installed at least on a plurality of vehicles;
(b) transmitting the data message on said wireless data communication network to at least one receiving device from a plurality of receiving computing devices connected to said wireless data communication network;
(c) receiving the data message on said at least one receiving computing device; and
(d) unless said at least one receiving computing devices is a destination computing device for the data message, further transmitting the data message from said at least one receiving device to at least one other receiving computing device until said destination computing device receives the data message, wherein at least two computing devices among said source computing device and said receiving computing devices are installed on said vehicles, at least one of said vehicles being an airborne vehicle.

### BRIEF DESCRIPTION OF THE DRAWINGS

The invention is now described with the assistance of the following drawings, wherein:

FIG. 1 is a diagram showing a network for wireless communication of messages having a plurality of nodes in accordance with the present invention;

FIG. 2 is a block diagram of hardware components for the present invention;

FIG. 3 is a block diagram of the architecture of the present invention for a terminal device for a first embodiment of the present invention;

FIG. 4 is Unified Modeling Language (UML) use case diagram for the Network manager layer of the present invention;

FIG. 5 is a block diagram showing services provided by the API layer of the present invention;

FIG. 6 is a block diagram of an architecture of terminal device for a second embodiment of the present invention;

FIG. 7 is a block diagram of an architecture of terminal device for a third embodiment of the present invention;

FIG. 8 is a UML use case diagram for the Positioning Services layer shown in accordance with the second and third embodiment of the invention;

FIG. 9 is a UML use case diagram for Positioning Services layer shown in accordance with the second and third embodiment of the invention;

FIG. 10 is a UML use case diagram showing the functionality provided by routing engine layer of the third embodiment;

FIG. 11 is a UML use case diagram for the Network Wrapper layer of the third embodiment;

FIG. 12 is a UML use case diagram for the Transport wrapper layer of the third embodiment;

FIG. 13 is a block diagram of a fire fighting system that advantageously makes use of the present invention;

FIG. 14 is an example of the Traffic View GUI provided by the Fire Fighting system of FIG. 13;

FIG. 15 is an example of an operational View GUI provided by the Fire Fighting system of FIG. 13;

FIG. 16 is an example operational view GUI provided by the Fire Fighting System of FIG. 13 showing map information;

FIG. 17 is an example of an instrument view GUI, with map information, provided by the Fire Fighting System of FIG. 13; and

FIG. 18 is an example of a text view user interface provided by fire fighting system of FIG. 14.

### DETAILED DESCRIPTION OF THE INVENTION

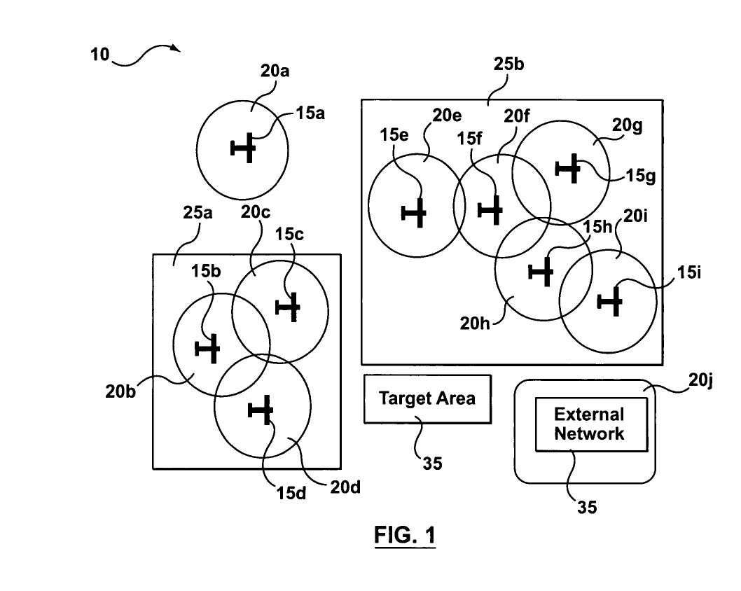

FIG. 1 is a diagram showing a network, shown generally as 10, for wireless communication of messages having a plurality of nodes 15, in accordance with an embodiment of the present invention. Node 15 is equipped with a terminal device having a wireless communications transceiver (WCT), which allows node 15 to communicate with other nodes 15, and a computing device (CD). WCT ensures that nodes 15 can communicate messages, including data messages, with each other.

Referring still to FIG. 1, a number of definitions are now offered for terms which will be used to describe the present invention. Node 15 may represent a large variety of objects, including, but not limited to: an aircraft, a land or sea based vehicle, a stationary communication station, or a human being or animal. However, node 15 must be equipped with a terminal device having a WCT, which allows node 15 to communicate with other nodes 15, and a CD. Node 15 constituting an aircraft having a terminal device is referred to as an aircraft node 15. Node 15 constituting a ground-based vehicle having a terminal device is a ground vehicle node 15. The present invention offers the ability for nodes 15 of any type, and aircraft nodes 15 in particular, to establish wireless communications between themselves for sharing messages.

Each node 15 has communication range 20. Communication range 20 is the maximum distance from which node 15 may wirelessly receive transmissions from, or wirelessly send transmissions to, another node 15 using node's 15 WCT. Two nodes 15 that have intersecting communication ranges 20 are neighbor nodes 15 as they may communicate directly with each other. Neighbor nodes 15 bare said to be in range of each other. For example, referring still to FIG. 1, nodes 15b and 15c are neighbor nodes 15. Two or more neighbor nodes 15 form cluster 25 within network 10, and may be referred to as cluster nodes 15. For example, node 15b, node 15c, node 15d are cluster nodes 15 for cluster 25a. Each cluster node 15 from cluster 25 can send and receive messages from any other cluster node 25.

Source node 15 initially generates a message. Destination node 15 is the intended final recipient for a message initially generated by source node 15. Hop node 15 is an intermediary which retransmits, i.e. repeats, message from source node 15 to another hop node 15 or destination node 15 for message. For example, source node 15e initially generates a message intended for final reception by destination node 15g. If the message is repeated by node 15f before reaching destination node 15g, node 15f is a hop node 15 for the message. If both hop node 15 and destination node 15 are neighbor nodes 15 to source node 15, the decision of whether to communicate message directly to destination node 15 or via hop node 15 may be based on a user-defined criteria such as data congestion or capacity of hop node 15 or destination node 15. It is this technique, referred to as multi-hopping for purposes of the present invention, that allows cluster nodes 15 that are not neighbor nodes 15 to nonetheless communicate messages to all other cluster nodes 15 of the same cluster 25, thus extending the distance over which nodes 15 may communicate with each other.

Referring still to FIG. 1, standalone node 15a is not a neighbor node 15. Thus, standalone node 15 cannot communicate with any other node 15. Further, cluster nodes 15 in cluster 25a cannot communicate with cluster nodes 15 in cluster 25b. However, should communication range 20 of standalone node 15 intersect simultaneously cluster nodes 15e of cluster 25b and cluster nodes 15c of cluster 25a, standalone node 15a will enable communication of all nodes 15 in clusters 25a and clusters 25b between each other and node 15 itself. When this occurs, clusters 25a and clusters 25b are merged. During this process, node 15a serves as contact node 15 for establishing communication. Once merging of cluster 25a and cluster 25b is complete, contact node 15 becomes a cluster node 15.

Node 15 may also allow for connectivity to an external network 30. For example, if communication range 20d of cluster node 15d and communication range 20j of external network 30 intersect, cluster node 15d may establish a connection to external network 30. Further, cluster node 15d can enable connectivity to external network 30 for all other cluster nodes 15 of cluster 25a to external network 30. In such cases, node 15d may be referred to as bridge node 15d between cluster 25 and external network 30. Bridge node 15d performs address translation between cluster nodes 15b and 15c of same cluster 25a and external network 30 and manages communications between cluster nodes 15 and external network 30. This capability allows network 10 provided by present invention to bridge to external networks 30 such as the Internet.

When the terminal device on node 15 is carrying out operations for that same node 15, node 15 is referred to as local node 15 for the operations. Local node 15 is the node 15 refers to a situation When the terminal device is carrying out operations for messages received or destined for other nodes 15, those other nodes 15 are referred to as remote nodes 15.

Each cluster node 15 within cluster 25 is aware, or is eventually made aware, of all other nodes 15 in cluster 25. Further, each cluster node 15 in cluster 25 maintains its own services and may communicate and access services on other nodes 15 in cluster 25, without accessing any node 15 that acts as a central server. Thus, network 10 provides services on a peer to peer (P2P) basis, and each cluster node 15 can fully access the services provided by any other cluster node 15 in the same cluster 25. Thus, cluster node 15 may be referred to as a peer, or peer node 15, of every other cluster node 15.

Since network 10 provided by the present invention provides for wireless communication of messages between nodes 15 that may be mobile, this increases the possibility that nodes 15 will constantly be joining or leaving clusters 15, and that the positions of cluster nodes 15 within cluster 15 will be constantly changing, thus changing the topology of clusters 25 and network 10. Given the high speed of aircraft, this is particularly likely to be the case for aircraft nodes 15. By allowing for addition of new cluster nodes 15 that have joined cluster 25 and for removal of nodes 15 that have left cluster 25, network 10 provided by present invention is capable of functioning on an ad hoc basis, i.e. as an ad hoc wireless network having P2P capabilities. The ad hoc character of network 10 ensures that network 10 is self-forming based on which nodes 15 have intersecting communication range 20, i.e. are neighbor nodes 15 or cluster nodes 15 in clusters 25. In addition, the ad hoc character of network 10 allows network 10 to continue to function despite removal of nodes 10 from clusters 10, thus providing a self healing capability for network 10.

Target area 35 is a geographical position or an object for which has been assigned. Target area 10 may be inside or outdoors. Target area 35 may also comprise a moving object including, but not limited to, a vehicle, human being, or animal.

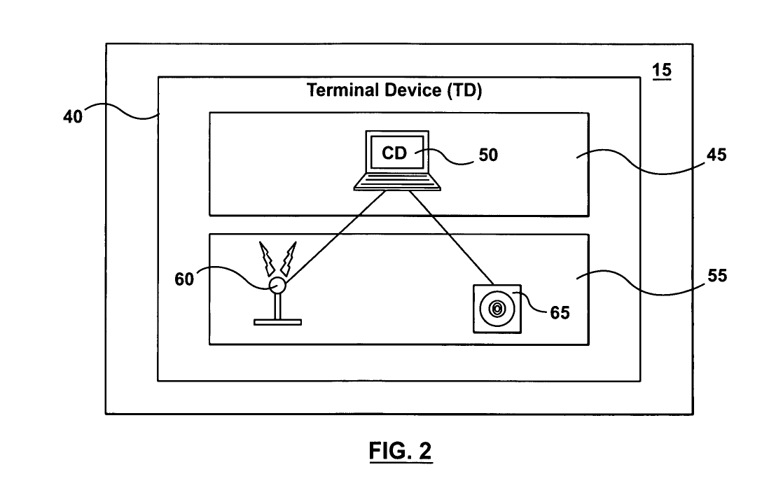

FIG. 2 is a block diagram of hardware components for the terminal device (TD) 40 for node 15 of network 10 according to the present invention. As stated, node 15 has at least one TD 40. TD 40 has two sets of hardware components. First set 45 of hardware components includes at least one computing device (CD) 50 on which applications are stored and run and which displays information for users and processes user requests. CD 50 is also responsible for managing communications with other nodes 15 and for providing data from other nodes 15 to applications. CD 50 may be any device capable of executing programs and input and output of data, such as a personal computer, a laptop computer, a tablet computer, a cellular phone, personal digital assistant, or the like. The only requirement is that CD 50 have sufficient processing power and memory to run applications associated with the present invention. CD 50 may, optionally, display information to users. Second set 15 of hardware components includes a radio frequency (RF) (WCT) 60, which is responsible for the physical transmission and reception of messages on a wireless basis to and from node 15, as instructed by CD 50. Second set 55 also includes at least one sensor 65 for sensing information. Sensor 65 may be of any type, provided that software in CD 50 is designed to use data provided by that type of sensor 65 and that CD 50 has interfaces designed to function with sensor 65. For example, sensor 65 may sense temperature, radiation, or position.

Sensor 65 and WCT 60 are connected to CD 50, either by wireless or wireline connections. It is not, however, necessary that CD 50, sensor 65, and WCT 60 of TD 40 be co-located in one container. For example, for aircraft nodes 15, WCT 60 could be at the back of the aircraft while CD 50 is in the cockpit.

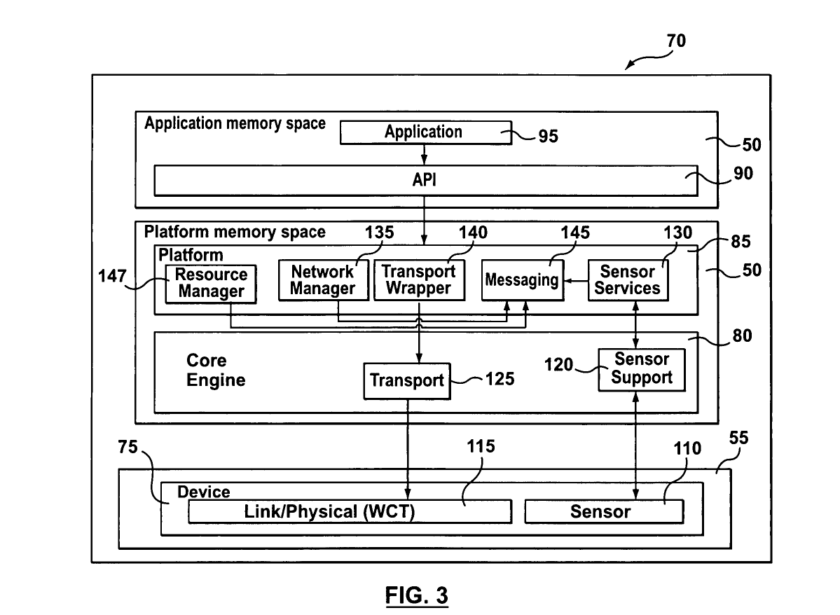

FIG. 3 is a block diagram of an architecture 70 for TD 40 of node 15 of network 10 according to a first embodiment of the present invention. Architecture 70 comprises both hardware components and software components. Architecture 70 is composed of four system layers: device layer 75, core engine layer 80, platform layer 85, and application programming interface (API) layer 90. Each system layer may be composed of other layers and includes all software routines and hardware components for that system layer. Device layer 75 includes WCT 60 and sensor 65 and provides a physical interface to incoming and outgoing messages which are received and sent by WCT 60, as well as for messages of data provided and detected by sensor 65. Platform layer 85 handles all aspects of information management, communication of messages between nodes 15, and use or availability of nodes 15 as part of clusters 25 or network 10 on an ad hoc P2P basis. Core engine layer 80 provides communication between the platform layer 85 and device layers 75. API layer 90 provides an interface to application 95 through which application 95 may access services provided through network 10, as made available through API layer 90.

Architecture 70 has been organized to allow for maximum versatility. Each system layer provides interfaces to the system layer directly beneath or below. This division of system layers and provision of interfaces ensures that any changes made to the implementation of a given system layer will not affect other layers in architecture 70, or at most one system layer below or above. This is particularly important when considering device layer 75 and core engine layer 80. For example, within device layer 75, WCT 60 or sensor 65, as well as interfaces for WCT 60 or sensor 75, may be implemented as stand alone third party components or customized components. Further, depending on the requirements of application 100, WCT 60 or sensor 65 and their interfaces may need to be replaced by other technologies. Since each system layer only communicates with the layer directly above or beneath it, such changes can be absorbed within device layer 75 and core engine layer 80, without affecting platform layer 85 or API layer 90. Similarly, changes to protocols used for network communication and transport of messages employed within core engine layer 80 may also be required or desirable. Again, platform layer 85 and API layer 90, as well as application 95, will not be affected, as they remain isolated from the implementation details of core engine layer 80.

Platform layer 85, core engine layer 80, and any drivers or software resident on CD 50 for device layer 75 reside in a platform memory space 100 on CD 50 specifically reserved for these system layers. Hardware interfaces to enable connections between WCT 60 and sensor 65 of device layer device layer 75 may also be implemented in part on CD 50. Typically, platform layer 85 is run as an executable that acts as a daemon or service to provide services to API layer 90. Application 95 and API layer 95 reside on CD 50 in a separate application memory space 105 reserved for application 95 and API layer 90. Further details of system layers and their interactions are provided below.

API layer 90 interacts with application 95 and functions as a call stub for application 95 in application memory space 105. API layer 90 communicates with system layers in platform memory space 100, notably platform layer 85, via inter-process communication or some other mechanism that protects the system layers in the system memory space 100. This is also the case for communication between layers within API layer 90 and layers within system layers located in platform memory space 100. This division of memory space and the running of platform layer 85, and possibly lower system layers, as separate processes from application 95 and API layer 90 reinforces separation of application 95 and API layer 90 from implementation of platform layer 85, core engine layer 80, and device layer 75. Thus, independence of application 95 and API layer 90 with regard to implementation of other system layers is enhanced. Platform memory space 100 and application memory space 105 may be located on CD 50 in Random Access Memory (RAM), Read Only Memory (ROM), Flash memory, or any combination thereof.

Device layer 75 includes second set 55 of hardware components. As such, device layer 75 includes WCT 60 and sensor 65 and provides a physical interface to incoming and outgoing messages which are received and sent by WCT 60, as well as for messages of data provided and detected by sensor Device layer 75 accesses all higher layers in architecture 70 through driver interfaces (not shown) for WCT 60 and sensor 65, which may be located on WCT 60, sensor 65, or CD 50. Provided the correct driver interface is present, core engine layer 80 will be able to access messages from, and provide messages and instructions to, WCT 60 and sensor 65, either for core engine layer's 80 own needs or on request of platform layer 85, which may, in turn, receive or transmit messages and instructions from API layer 90. This design further facilitates independence of platform layer 85, and therefore API layer 90 and application 95, from specific WCT 60 and sensor 65 implemented at device layer 75.

Device layer 75 encapsulates two additional layers: sensor layer 110 and link/physical layer 115. Sensor layer 110 includes sensor 65 and provides sensor data to core engine layer 80. Link/Physical layer 115 is the base layer for wireless communications. Link/Physical layer 115 includes WCT 60. Thus, link/physical layer handles the physical transmission and reception of radio signals between end-users using CDs 50 on different nodes 15 and provides link layer support for point to point and point to multipoint communications. Point-to-point communications and point-to-multipoint communications are essential for application 95 as such a capacity allows node 15 to transmit to one node 15 or multiple nodes 15 simultaneously. This, in turn, allows for rapid repeating of messages to other nodes 15 to ensure that messages can traverse multiple routes, using multi-hopping if required, to reach destination nodes 15 from source node 15. This, in turn, maximizes the probability that the message will reach destination node 15 and that destination node 15 will be reached as quickly as possible. Maximizing reliability and speed of transmission is especially important for aircraft nodes 15 since, given the high speed of aircraft, aircraft nodes 15 will change position very quickly and will move in and out of clusters 25, thus affecting availability of aircraft nodes 15 and routes from source node 15 to destination node 15.

Link/physical layer 115 and sensor layer 110 may comprise any drivers or hardware interfaces necessary for interaction with other layers, notably core engine layer 80, although these drivers and interfaces may also included on CD 50 in core engine layer 80 itself. From a practical perspective, however, link/physical layer 115 can be considered to be the equivalent of WCT 60, encapsulated in a layer for design purposes. Similarly, sensor layer 110 can be considered to be equivalent of sensor 65.

Core engine layer 80 provides all core engine layer 80 services to platform layer 85, which uses core engine layer 80 services to carry out instructions received from application 95 over API layer 90. Core engine layer 80, in turn, uses device layer 75 to physically communicate messages using WCT 60 of link/physical layer 115 and to receive data from sensor 65 in order to provide core engine layer 80 services. Thus, core engine layer 80 acts as an interface between platform layer 85 and device layer 75. Among core engine layer 85 services is routing, which provides for routing of messages, using multi-hopping if required, between nodes 15. The exact means by which routes are determined or provided depends upon the actual routing protocol used and is hidden from the platform layer 85 and API layers 90. This ensures that routing protocol can be adapted to WCT 60 of link/physical layer 115 at core engine layer 80 without affecting platform layer 85 or API layer 90. Core engine layer 80 includes, at a minimum, sensor support layer 120 and transport layer 125.

Transport layer 125 is responsible for passing all forms of messages between API layer 95 of a node 15 and other nodes 15 using link/physical layer 115 (WCT 60) at device level 75. Transport layer 125 is capable of providing connectionless asynchronous transport, such as use of Internet protocol (IP) or the like, of messages as well as connection-oriented transport, such as use of transmission control protocol (TCP) or the like, for messages. Connectionless asynchronous transport service is important for the present invention as it provides for faster delivery of time sensitive messages by avoiding connection set-up overhead and maintenance transfer. This is especially useful when application 95 involves aircraft nodes 15. Since aircraft travel at high speeds, nodes 15 will rapidly leave and enter clusters 25, thus making maximal speed of transport essential. However, for messages that may be mission critical, it may be desirable to maximize reliability of transport. In such cases, connection-oriented services are provided for reliable message communication.

Sensor Support layer 120 parses and processes sensor 65 data from sensor layer 110. Sensor support layer 120 provides an abstract interface for sensor services layer 130 of platform layer 85, which provides services for sensor 65 based data, provided from sensor layer 110, to application 95 via API layer 90. Sensor Support layer 120 is responsible for processing sensor data from sensor layer 110.

Platform layer 85 receives and manages all requests for services from applications via API layer 90. Specifically, platform layer 85 manages all communication of messages between nodes 15, notably on a P2P basis, and provides all services for messages provided by sensor layer 110 to application 95 via API layer 90. Platform layer 85 is composed, at a minimum, of the following layers: network manager layer 135, transport wrapper layer 140, messaging layer 145, resource manager layer 147, and sensor services layer 130.

Network manager layer 135 maintains a table of all current network information relating to all known nodes, such as node identifiers (node ID) and other information useful for management of nodes 15 as network 10 or cluster 25. Network manager layer 135 is responsible for discovery of nodes 15, exchange of network information relating to nodes 15 as part of network 10 or cluster 25, addition and deletion of nodes 15 as part of network 10 or cluster 25, configuration of network settings, and updating and broadcasting the presence of all nodes 25 accessible on network 10 or cluster 25 as peers. Network manager layer provides the following services:

Naming/Identity/Addressing service maintains a peer node's 15 identity and uses a network management protocol to communicate with other peers nodes 15 and to exchange network information.

Neighborhood service provides up to date information about peer nodes 15 that are neighbor nodes 15 in order to enhance resolution of identity of peer nodes 15.

Session management service maintains the collaborative service for initiating, terminating and restoring P2P services and P2P communication sessions between nodes 15.

History service maintains a cache of information about the activities of a peer node 15, such as, among other things, how routes to peer node 15 were established, the content of previous messages communicated between peer node 15 and other peer nodes 15.

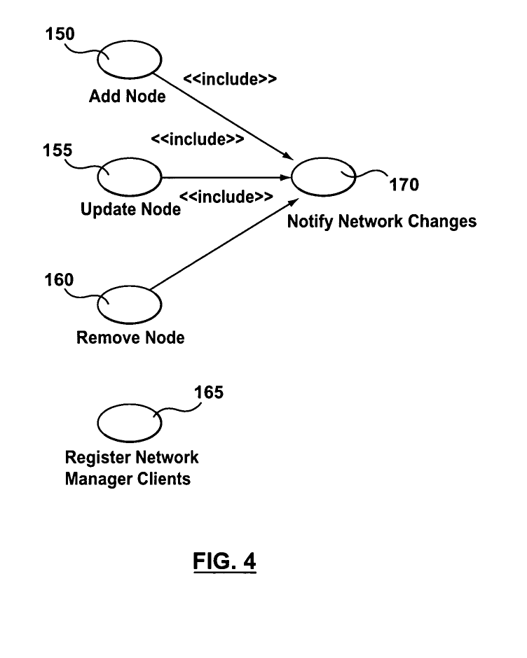

To better aid the reader in understanding network manager layer 135, reference is now made to FIG. 4, a Unified Modeling Language (UML) use case diagram for Network manager layer 135. The operation of the Network manager layer 135 includes the following use cases: Add node use case 150, Update Node use case 155, Remove node use case 160, Register Network Manager Clients use case 165, and Notify Network Changes use case 170. Add node use case 150 is started when a new node 15 is detected by another node 15. A node ID, which may comprise an IP address, MAC address, or other identifier is assigned to new node 15 and is propagated across cluster 25 or network 10 to ensure that every node 15 is informed of new node 15. Update node use case 155 is started when local node 15 receives updated network information from another, remote node 15. The local node 15 and remote node 15 negotiate IP addresses (connections) and broadcast the results.

Remove Node use case 160 is started when node 15 in cluster 25 is found to be unreachable, i.e. has become a standalone node 15 or is otherwise unreachable. The unreachable status of node 15 is broadcast across cluster 15 to remove knowledge of unreachable node 15 from cluster nodes 15, notably from network manager layer 135 in each cluster node 15. Also, should a routing table be used to track routes, unreachable node 15 will be removed from this table. Register Network Manager Clients use case 165 is started to register/unregister clients of Network manager layer 135r, notably application 95 and components of API layer 90, for receiving network information update messages, which update information about network 10 or cluster 25. Notify Network Changes use case 170 is started to notify the registered clients of Network Manager layer 135 of network changes, such as node addition, removal, and update.

Returning now to FIG. 3, Transport wrapper layer 140 is a predefined interface between transport layer 125 and API layer 90. Transport wrapper layer 125 provides a standard set of interfaces that can be accessed by application 95 through API layer 90 to invoke services of transport layer 125, or through messaging layer 145. Network manager layer 135 may also access transport wrapper layer 140 directly. Transport wrapper layer 140 keeps all details of transport layer 125 implementation hidden from higher layers.

Messaging layer 145 is used for exchanging system information between peer nodes 15. Such system information may be encapsulated in multiple message types including, among other things, sensor information, network information about the entire network 10 as a P2P system, and status information for nodes 15 that are peer nodes 15. Since there are multiple message types used at messaging layer 145, messages for messaging layer 145 are encoded in a language that allows for self-definition of data and message types, such as extensible markup language (XML). This allows for creation of datagrams for various messages types that are destined for messaging layer 145. Use of UML and datagrams ensures that such messages can be easily sorted and processed. Messaging layer 145 can also provide services to application 95 via API layer 90, and could potentially be used to remotely invoke methods and objects on remote nodes 15.

Resource Manager layer 147 manages application data that is shared across network 10 on a P2P basis, i.e. data from application 95 that is shared by application 95 among peer nodes 15. Resource Manager layer 147 relies on other components and layers in Platform layer 85 and provides an abstract and consistent view of all data on network 10 on a P2P basis.

Sensor services layer 130 provides messages from sensor layer 110 (i.e. sensor 65) via sensor support layer 120, to application 95 through API layer 90. Thus, sensor services layer 130 provides high level sensor services to application 95 through API layer 90. Sensor services layer 130 sends and receives messages about sensor related information from sensor support layer 120 of core engine layer 80. Sensor Services layer 130 manages all sensor related information for each node 15 in network 10, as requested by application 95. Sensor services layer 130 is not an integral part of network 10 for P2P purposes. Therefore, sensor services layer 130 maintains a separate information database or table from that of network manager layer 135. This information is indexed by node ID or other identifier.

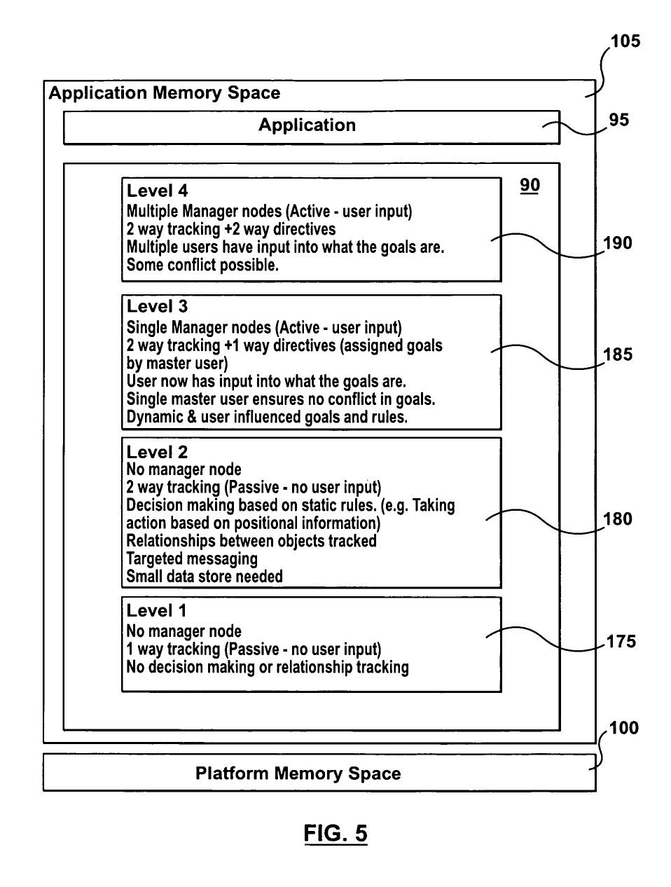

FIG. 5 is a block diagram showing services provided by API layer 90. API layer 90 can provide a variety of services of varying complexity to application 95. At least complex level, level 1 175, API layer 90 will provide application 95 with simple peer to peer communication between nodes 15 with no node 15 being designated by application 95 as managing node 15 for controlling other nodes 15. Tracking of other, remote nodes 15 is one way in that local node 15 receives messages from remote nodes 15 but local node 15 does not attempt to ensure that remote nodes 15 receive messages sent by local node 15. Since local node 15 simply broadcasts local node's 15 messages without two-way communication with remote nodes 15, relationships between nodes 15 are not tracked and no decision making ability is furnished by API layer 90 to application 95.

At level two 180, there is also no managing node 15 Tracking remains passive with no user input, but each local node 15 tracks all remote nodes 15 by attempting to ensure that remote nodes 15 receive local node's 15 messages. This allows for tracking of relationships between nodes 15 and for targeting of messages from one specific source node 15 to a destination node 15. Application 95 is provided with some decision making ability based on static rules in accordance with information provided by sensor layer 110, such as, among other possibilities, positional information.

At level three 185, API layer 90 allows application to designate one managing node 15. Managing node 15, relying on messages from sensor layer 10, i.e. sensor 65, and user input, provides directives or assigns tasks to remote nodes 15. Thus, a user can use CD 50 on managing node 15 to assign such tasks. Since API layer 90 at level three 185 allows user to set rules and tasks, rules and tasks may become user-defined and dynamic. Since there is only one managing node 15, API layer 90 will not allow application 95, or users, to create conflicts in tasks.

At level four 190, the most complex level, API layer 90 allows multiple managing nodes 15. Each local node 15 tracks all remote nodes 15 and messages sent from local node 15 to remote nodes 15, providing two-way tracking. As there may be multiple managing nodes 15, multiple users at multiple managing nodes 15 may assign tasks and rules using CDs 50 on managing nodes 15. Tracking status of all node's 15 allows for resolution of conflicts in assigned tasks.

Using the API layer 90 services, users can rapidly implement application 95 that uses these services. In addition, users may gradually develop application 95, adding complexity to application 95 as services required by application 95 progress from level 1 175 to level 4 190.

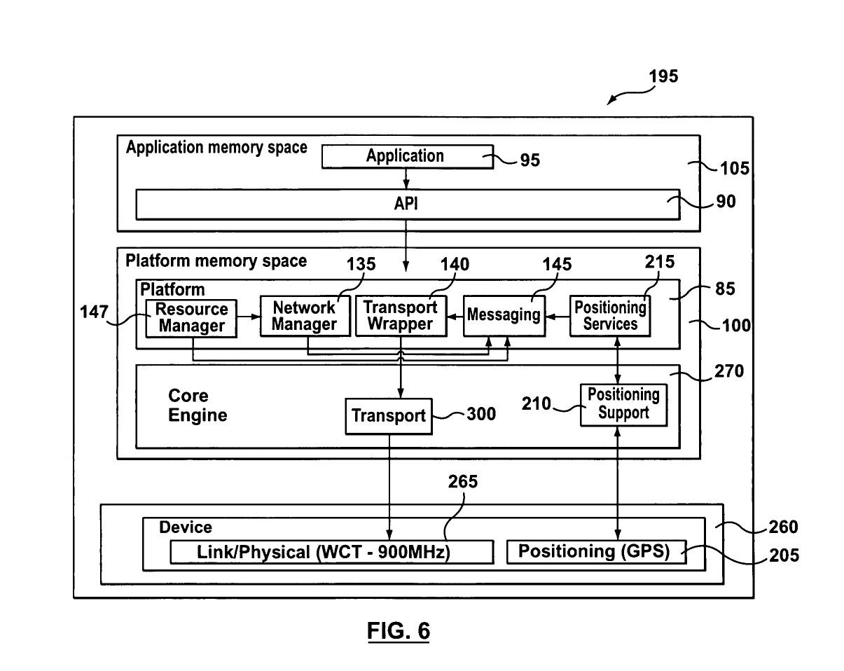

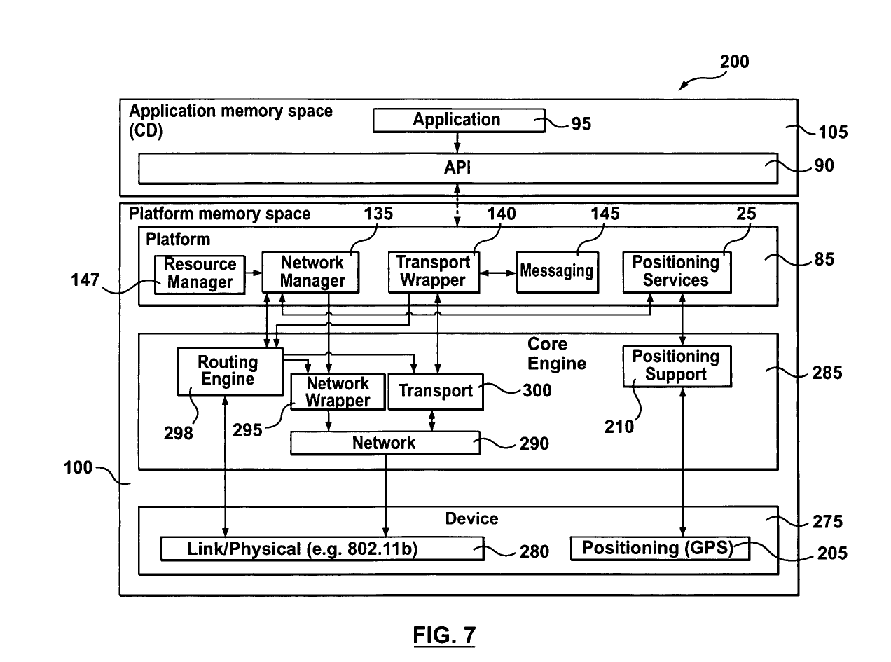

FIG. 6 is a block diagram of an architecture 195 for TD 40 of node 15 of network 10 according to a second embodiment of the present invention. FIG. 7 is a block diagram of an architecture 200 for TD 40 of node 15 of network 10 according to a third embodiment of the present invention For architecture 195 of the second embodiment and architecture 200 of third embodiment, architecture 70 of first embodiment is refined for use with sensor 65 that senses position, i.e. a GPS receiver, and a specific WCT 60. Thus, in architecture 195 of the second embodiment and architecture 200 of the third embodiment, sensor layer 110, i.e. GPS receiver, is referred to as positioning layer 205. Sensor support layer 20 and sensor services layer of architecture 70 of the first embodiment are referred to, respectively, as positioning support layer 210 and positioning services layer 215 in architecture 195 of the second embodiment and architecture 200 of the third embodiment Platform layer 85 and API layer 90 have the same structure for all three embodiments, again demonstrating the independence of platform layer 85 and API layer 95 with regard to lower platform layers.

Common elements of architecture 195 of second embodiment and architecture 200 of the third embodiment are described initially. Elements specific to architecture second embodiment are described next. A description of elements of third embodiment is then provided.

Referring again to FIGS. 6 and 7, for architecture 195 and architecture 200 of the embodiments, nodes 15 provide to each other messages, for use by application 95, that include geographical and navigational information for nodes 15, such as geographical position of nodes 15, speed of nodes 15, direction of nodes 15, distance from target areas 35 and navigational instructions for attaining target areas 35, or the like. Such geographical positional information and navigational information is derived from GPS signal data, i.e. a GPS position, received at (GPS) positioning layer 205.

Positioning layer 205 physically receives GPS data in the form of formatted sentence types. Currently, most hand-held GPS receivers support the NMEA 0183 standard. Popular aviation receivers built by Garmin use a similar format called the Aviation Data Format.

Positioning support layer 210 parses and processes (GPS) signal position data, i.e. sentences, from positioning layer 205 on node 15 as well as GPS data received from other nodes 15. Parsed GPS data is then made available by positioning support layer 210 to positioning services layer 215.

Positioning Services layer X215 manages all positioning related information pertaining to each node 15 in network 10. Therefore, positioning services layer 215 receives processed (GPS) positional data from positioning support layer 210 and performs all necessary calculations and transformations on the (GPS) positioning data to provide geographical positional and navigational information requested by application 95 using API layer 90. Positional and navigational information may include location of nodes 15, speed of nodes 15, direction of nodes 15, distance from target areas 35 and navigational instructions for reaching target areas 35, among other things. Positioning service layer 215 is not an integral part of the network 10 and maintains its own separate information database or tables. Such database may include a geographical information system (GIS), which may provide maps upon which geographical positional information and navigational information may be cross-referenced. The map and cross-referenced positional information and navigational information may then be requested or accessed by application 95 using API 90 and displayed by application 95 on CD 50. Information stored in positioning services layer 215 database or tables is indexed by node ID.

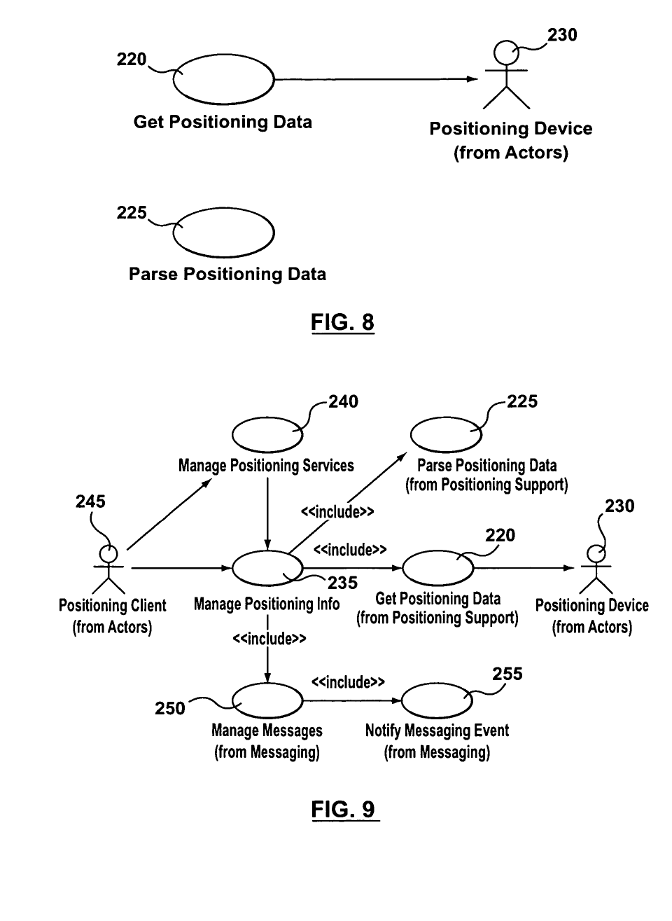

In order to aid the reader in understanding positional services layer, reference is now made to FIG. 8, a UML use case diagram for the Positioning Support layer 215 shown in FIGS. 6 and 7. The operation of positioning layer includes the following use cases: Get (GPS) Positioning Data use case 220 and Parse Positioning Data use case 225. Positioning Device Actor 230 represents positioning layer 205, i.e. a GPS receiver. Positioning Device Actor 230 allows node 15 to receive positioning information, such as GPS positioning information, from satellite or other sources.

Get Positioning Data use case is invoked to communicate with positioning layer 225 and retrieve positioning data. Parse Positioning Data use case 230 parses positioning data and extracts positioning information from them.

FIG. 9 is a UML use case diagram for Positioning Service layer 215 of FIGS. 6 and 7. As shown in FIG. 9, the operation of the Positioning Services layer 215, with positioning layer 205 comprising a GPS receiver, includes: Manage Positioning information use case 235 and Manage Positioning Services use case 240. Positioning Services layer 215 also references Device actor 230 represents positioning layer 205, i.e. a positional transceiver such as GPS a transceiver. Positioning Client actor 245 represents application 95.

Manage Positioning Information use case 235 is invoked when positioning information is received from positioning layer 205 device or remote node 15. Manage Positioning Information use case 235 includes manage messages use case 250 and notify messaging event use case 255 from the use cases for messaging layer 145 of platform layer 85. Manage Positioning Information use case 235 includes the following activities (not shown): Update Local Positioning Information activity, Update Remote positioning Information activity, Retrieve Positioning Information activity, and Retrieve Positioning Extension activity.

Update Local Position Information activity retrieves and processes local position information from the positioning layer 205 periodically at a pre-configured frequency for node 15 which invokes Manage Positioning Information use case 235. Update Local Position Information activity notifies the registered clients of position information changes for node 15 and broadcasts the local position information to all other nodes 15 in cluster 25.

Update Remote Positioning Information activity is started to update remote position information for nodes 15 on the network 10. To this end, Update Remote Position Information activity first receives and processes position information from remote nodes 15. Update Remote Position Information activity then notifies position information changes to the registered clients, e.g. application 95.

Retrieve Positioning Information activity is started by the Positioning Client actor 245, such as application 95. The Positioning Client actor 245 receives a positioning information notification from positioning services layer 215 and retrieves the positioning information.

Retrieve Positioning Extension activity is started by the Positioning Client actor 245, such as an application 95. The Positioning Client actor 245 receives a positioning extension notification from the Positioning Services layer 215 and retrieves the positioning extension.

Manage Positioning Services use case 240 commences when application 95 chooses to manage the positioning services offered by Positioning Services layer 215. The Manage Positioning Services use case 240 ends when the operation is completed with or without success. Manage Positioning Services use case 240 includes the following activities (not shown): Load Settings activity, Save Settings activity, Start Services activity, Stop Services activity, Register Client activity, Unregister Client activity, Set Extension Cache activity.

Load settings activity and Save Settings activity are invoked when positioning services layer is started/stopped, respectively, to load or save configuration settings for positioning services layer 205.

Start services activity and stop services activity are invoked, respectively, to start or stop positioning services layer 205.

Register Clients activity and Unregister Client Activity are invoked, respectively, to register and unregister Positioning Services layer clients, such as application 95 using API layer 90, for receiving messages for updating (GPS) positioning information update messages.

Set Extension Cache activity is invoked by the Positioning Services Client actor 245, such as application 95, to append application specific extensions to the positioning messages. The extension cache is defined by a callback interface and implemented by application 95 so that positioning services layer 215 is able to retrieve extensions to append when it sends out positioning messages.

Reference is now made again to FIG. 6 to explain the details specific to architecture 195 of TD 40 for the second embodiment. Communications are provided at device layer 260 by link/physical layer 265, which comprises WCT 60 that uses a Frequency Hopped-Time Division Multiple Access (FH-TDMA) method the in 900 MHz band. In the FH-TDMA method, all nodes 15 cycle synchronously through a series of frequency channels in the 900 MHz band. This aspect of the method, known as frequency hopping, ensures that all nodes 15 broadcast on the same frequency channel at the same time, and thus minimizes interference with transmission from other wireless systems. Under the TDMA aspect of the FH-TDMA method, each frequency channel is divided into multiple time slots, with different nodes 15 receiving different, unique time slots, which are then multiplexed and broadcast over the channel. In this fashion, multiple nodes 15 can be broadcast over the same channel without interference.

For this embodiment, the number of nodes 15 is limited prior to use of the embodiment to a fixed quantity As such, a fixed Node ID is allocated to each node and maintained in a static table maintained in the network manager layer 135. Each node's 15 network manager layer 135 has a copy of this table containing node IDs of all nodes 15. Each node 15 is aware of its own node ID. Each message, which contains the node ID of destination node 15, is transmitted and repeated, i.e. retransmitted, to all nodes 15 and each node 15 that receives the message verifies whether it is destination node 15. If so, node 15 processes the message. This hard-coded node ID scheme ensures that each node 15 will be recognized by others on the network.

Use of 900 Mhz band is advantageous in that the 900 MHz band provides for an extended communication range 20 for transmission between nodes 15. This extended range between nodes 15 extends range of network 10 and clusters 25. However, the 900 MhZ band with FH-TDMA offers limited bandwidth for communicating messages. It is for this reason that number of nodes 15 is limited.

Use of the FH-TDMA method in an ad hoc environment requires accurate time references for both FH and TDMA aspects. Time must be synchronized between nodes 15 to ensure nodes 15 are cycling through the same frequency at the same time. Further, time reference must be accurately synchronized to allow link/physical layer 265, i.e. a TCW broadcasting using 900 MHz band, to join the frequency. In addition, from a TDMA perspective, accurate time reference and synchronization are required for time-slot allocation and to ensure correct use of time slots allocated to nodes 15. In a centralized network, such a time reference could be provided by a reference time signal from a base station or even a mobile managing node 15. However, in a highly dynamic ad hoc environment involving aircraft nodes 15, where node 15 availability and position change extremely rapidly due to the high speed of aircraft nodes 15, a centralized approach is not practical. This impracticality is due to the fact that the position and accessibility of any one node 15 designated for timing may change more quickly than other nodes' 15 ability to access and receive timing data from that node 15. To overcome this problem, the embodiment employs positioning layer 205, i.e. GPS transceiver, which provides a precise timing pulse (1 PPS). Using the timing pulse, each node 15 can initialize its link/physical layer 265 and be sure that transmission and reception of messages is synchronized with other nodes 15. This time synchronization method is further useful for allowing a node 15 to operate, albeit with degraded functionality, as standalone node 15. In this case, when a connection to another node 15 is re-established, the timing pulse can be used to re-establish time synchronization with other nodes 15.

Referring still to embodiment shown in FIG. 6, in order to maximize probability that a data message from source node 15 will be received by destination node 15, each hop node 15 repeats each message received to all other nodes 15. Similarly source node transmits all messages to all other nodes 15 to maximize the possibility that message will be repeated by all nodes 15 and will eventually reach destination node 15, This repeating method for multi-hopping is a form of flood routing and is controlled and configured through firmware at link/physical layer 265. If receiving node 15 is destination node 15, data message is sent to core engine layer 270.

All nodes 15 constantly update their data and transmit this data in data messages at very frequent intervals, i.e. at least once per second. The rapid frequency of updating information is particularly useful for aircraft nodes 15. Due to the speed of aircraft nodes 15, data in messages, especially geographical positional and navigational data, becomes outdated very rapidly. Thus, should a destination node 15 be unavailable or inaccessible, it is not necessary to attempt to spend resources trying to reestablish a connection for the message originally sent by source node 15. Source node 15 will simply send a new, updated message which will be transmitted and repeated to attempt to reach destination node 15. This process continues constantly, with all nodes 15 acting as source nodes 15 and transmitting data messages with their latest information, ensuring that a maximum number of nodes 15 receive updated messages while maximizing the possibility that a specific message for a specific destination node 15 will be received.

It is possible to implement more advanced methods of flood routing than simply transmitting and re-transmitting of all messages to all nodes 15. More advanced methods for flood routing could be implemented, for example, at the core engine layer 270. Since these changes would be made to the core engine layer 270, they could be implemented without affecting application 95, application layer 90, or platform layer 80. Thus application 95 would not be affected. In all other aspects, architecture 195 of TD 40 of the second embodiment is similar to architecture 70 for the first embodiment.

To assist the reader in understanding the specific aspects of the architecture 200 of the third embodiment, reference is now made to FIG. 7. In this embodiment, at device layer 275, link/physical layer 280 comprises WCT 65 using 802.11 protocol over 2.4 GHz band. Functioning of positioning layer 205, positioning support layer 210, positioning services layer 215 are similar to second embodiment shown in FIG. 6. Functioning of API layer 95, and platform layer 85 are the same as in second embodiment shown in FIG. 6 and first embodiment shown in FIG. 3. This, again, demonstrates independence of platform layer 85 and API layer 90 from lower layers in all embodiments, allowing for application development independent of hardware used at link/physical layer 275.

Use of the 802.11 protocol in the embodiment provides a number of advantages. First, 802.11 protocol interfaces and drivers are readily available on an off-the-shelf commercial basis for a large number and variety of CDs 50. This makes integration of link/physical layer 275, i.e. WCT 60 using 802.11 protocol at 2.4 GHz band, with CD 50 relatively easy. Further, use of 802.11 protocol in the 2.4 GHZ band provides for relatively high bandwidth, at least compared to FH-TDMA at 900 MHz. Thus, architecture 200 for the third embodiment is capable of supporting a comparatively larger number of nodes 15, namely 5-20 nodes 15 per cluster 25 or in network 10.

The communication range between two nodes 15 using 802.11 in the 2.4 GHz band is relatively limited (approximately 300 feet) compared to nodes 15 using FH-TDMA over 900 MHz band. However, once again, by repeating messages using hop nodes 15, i.e. multi-hopping, a source node 15 and destination node 15 may be able to communicate over a distance of up to 5 and 20 miles. The distance over which source node 15 and destination node 15 can communicate will depend on, among other things, the number of nodes 15 available for repeating messages and the relative positions of each node 15.

Referring still to FIG. 7, messages are not transmitted and repeated from each node to every other node 15. Rather, a specific route or routes from sending node 15 to destination node 15, using multi-hopping between source node 15 and destination node 15, is used. This approach is advantageous since the bit error rate over a wireless channel tends to increase with the distance between nodes 15. Thus it is possible that a multi-hopped route using hop nodes 15 may be more effective than a direct communication route between sending node 15 and destination node 15 as neighbor nodes 15. By tracking potential routes, efficiency of communication may be increased by allowing nodes 15 to choose the most efficient communication route.

Tracking of multiple routes involving multi-hopping raises a number of difficulties. Once again, for application 95 designed for aircraft nodes 15, nodes 15 may quickly become unavailable, causing interruptions along routes and unavailability of nodes 15. Thus, node 15 along a route must be able to manage and gracefully recover from connection failures if neighbor node 15 with which node 15 is communicating along the route becomes unavailable. This may involve choice of another route. It may also be necessary to make provision for degraded operation so that a node 15 may remain operational as a standalone node 15 if required. In this case, when a connection is re-established, there either has to be some kind of synchronization scheme or a method to let communication of an interrupted message resume from where it stopped.

Given that availability of nodes 15 and topology of cluster 25 or network 10 may change constantly and rapidly, addressing the difficulties described above for tracking and using specific routes that involve multi-hopping requires that routing information for routes must be updated frequently on all nodes 15. Further, information regarding changes to the topology of nodes 15 in cluster 25 or network 10 must reach other nodes 15 affected. Network 10 must be able respond and recover from routes broken in mid-connection between source node 15 and destination node 15 by quickly determining a new route to ensure that the end-to-end connection from source node 15 to destination node 15 is not lost. Nodes 15 must constantly be aware of the topology of nodes 15 for cluster 15 or network 10 to ensure that only the most efficient routes are used.

In the embodiment, the number of nodes 15 used is not fixed prior to use. Thus, the number of nodes 15 may increase or decrease at any time and new, previously unknown nodes 15 may be added at any time. Thus, hard coding of Node IDs in a static table is not appropriate for the embodiment. Rather, a naming service or means of assigning unique IP addresses for nodes 15 is required for node 15 management in an 802.11 context. Standard Domain Name Services (DNSs) using centralized domain name servers may not be useful or available given that nodes 15 may be located on aircraft nodes 15 that may not be in range of the DNS server. Also, use of centralized servers is incompatible with the ad hoc nature of network 10. For similar reasons, use of traditional Dynamic Host Configuration Protocols (DHCP) that rely on a centralized DHCP server is also not useful. However, for the embodiment, a distributed IP address resolution algorithm may be used to allocate unique IP addresses for communications between nodes 15.

The distributed IP address resolution used for the embodiment is based upon four assumptions:
1. The media access control (MAC) address for each node 15 is globally unique and used as the node ID for each node 15.
2. A public IP (version 4, or IpV4) address space is available.
3. An evenly distributed and efficient hashing algorithm is available.
4. Each node 15 periodically broadcasts messages communicating that node's Node Id and other information to other nodes 15. This message may be referred to as a hello message.

The distributed IP address resolution algorithm uses a portion, A, of the public address IP space (e.g. IPv4 type C), which is allocated for the address resolution algorithm. Node 15 uses its MAC address as node's 15 Node ID. Node's 15 CD 50 keeps a monotonically increasing index in its registry. CD 50 of node 15 derives an (IPV4) address by hashing its MAC address and the index. The index is incremented by one after each address computation. If the IP address space in the algorithm is large compared to the number of nodes 15, the likelihood of conflicting, i.e. duplicated, IP addresses is small. The IP address resolution overhead is expected to be small.

An example of application of the distributed IP address resolution algorithm is now provided. If a standalone node 15 that has no IP address, comes into range of cluster 25, standalone node 15 realizes that it is not part of cluster 25 and initiates the distributed DHCP IP address resolution algorithm, as described above. Thus, standalone node 15 derives a proposed IP address for use in communication with nodes 15 in cluster 20 and broadcasts the proposed IP address. A receiving cluster node 15 receives the proposed IP address of standalone node 15 and receiving cluster node 15 checks to ensure that the received proposed IP address is not in conflict with existing IP addresses already used by nodes 15 in cluster 25. If the proposed IP address for standalone node 15 is not in conflict, the receiving cluster node 15 broadcasts back a confirmation data message to standalone node 15 indicating that standalone node 15 may use the proposed IP address. If proposed IP address is already in use by any (cluster) node 15 in cluster 25, receiving cluster node 15 broadcasts back a rejection message indicating that standalone node 15 may not use proposed IP for communication with nodes 15 in cluster 25. Standalone node 15 then repeats the distributed IP address process IP and broadcasts new proposed IP addresses until a unique (proposed) IP address is resolved, i.e. when receiving cluster node 15 sends a confirmation message to standalone node 15 that standalone node 15 may use proposed IP address to communicate with nodes 15 in cluster 25. After standalone node 15 obtains a unique IP address, standalone node retrieves network information about cluster 10 from receiving cluster node 15. Receiving cluster node 15 then sends information about (former) standalone node 15, including the confirmed IP address, to all other cluster nodes 15 in cluster 25. Standalone node 15 then joins cluster 25 as a new cluster node 15.

As a second example of use of the distributed IP address resolution algorithm, suppose a first cluster 25 comes into contact with a second cluster 25, when two cluster nodes 15, one from each cluster 25, come into range of each other. In such a situation, these two nodes 15, referred to contact nodes 15, exchange network information including IP addresses of all nodes 15 in each cluster 25. One contact node 15, for example contact node 15 from first cluster 25, checks the IP addresses within first cluster 25 and resolves any conflicting IP addresses within first cluster 25 by informing those cluster nodes 15 in first cluster 25 that they need to invoke the distributed IP address resolution algorithm to generate new IP addresses and resolve conflicts. The cluster nodes 15 so informed in first cluster 25 then apply distributed IP address resolution algorithm to derive new unique IP addresses within first cluster 25 and communicate the new IP addresses to contact node 15 of first cluster 25. Contact node 15 of first cluster 25 then verifies whether the new IP addresses conflict with IP addresses used by cluster nodes 15 nodes in second cluster 25. If a new IP address is found in conflict, contact node 15 of first cluster 25 negotiates with the cluster node 15 in first cluster 25 that has conflicting IP address for yet another new IP address. When all the conflicting IP addresses are resolved, they are passed to contact node 15 of second cluster 25. The changes in IP addresses are then broadcast to all nodes 15 in both clusters 25 and first cluster 25 and second cluster 25 are merged.

Referring still to FIG. 7, the details specific to the architecture for the embodiment are now described. As noted previously, link/physical layer 280 comprises WCT 65 using 802.11 protocol over 2.4 GHz band. Positioning layer 205 is a sensor 65 for positioning, i.e. a GPS transceiver. In the embodiment, core engine layer 285 includes network layer 290, network wrapper layer 295, routing engine layer 298, transport layer 300 and positioning support layer 210. As described previously, core engine layer 285 provides the interface between platform layer 80 and device layer 275 and ensures that link/physical layer 280 and positioning layer 205 can be altered without affecting API layer 90 or platform layer 85.

In the embodiment, network layer 290 communicates transport layer data messages from transport layer 300 on one node 15 to transport layer 300 on one or more different nodes 15. Thus, network layer 290 provides point-to-point duplex communication between neighbor nodes 15. Network layer 290 interacts with all other layers (platform layer 85, API layer 90, and device layer 275 through pre-defined interfaces and thus may be easily replaced to adapt to changes at link/physical layer 280.

Network Wrapper layer 295 is the predefined interface between the Network layer 290 of core engine layer 285 and Network Manager layer 135 of platform layer 85. Network wrapper layer 295 provides a standard set of interfaces so that all network layer 290 details are hidden from network manager layer 135. Once again, this helps to ensure that platform layer 85 and API layer 90, and therefore application itself 95, can function regardless of implementation details of lower levels, such as core engine layer 285 and device layer 275.

Routing Engine layer 298 is responsible for discovery and maintenance of routes between nodes 15, including use of multi-hopping. As such, routing engine layer 295 also contributes to ad hoc nature of network 10.

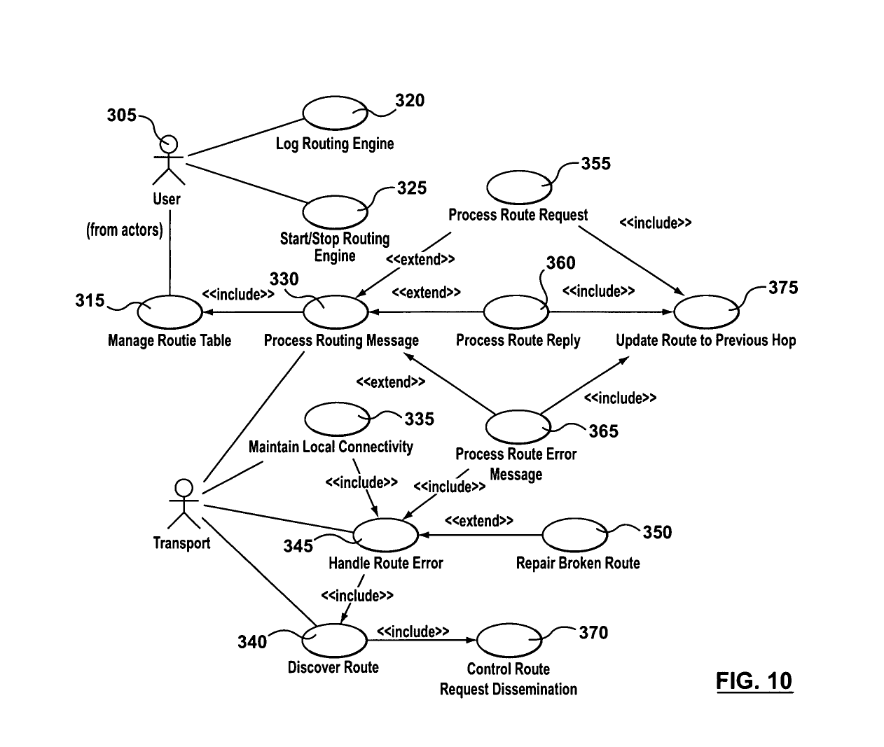

FIG. 10 is a UML use case diagram showing the functionality provided by routing engine layer of the third embodiment shown in FIG. 7. User actor 305 is a human user of a CD 50 or an external system. Transport actor 310 represents the transport layer 300 and transport wrapper layer 140. Transport layer 300 receives instructions and data messages from routing engine layer 298 and transport wrapper layer 140 provides instructions and messages to routing engine layer 298. Transport layer 310 and transport wrapper layer 140 allow routing engine layer 298 to send and receive messages containing control packets for establishing routes and connections.

Routes are maintained in table stored in routing engine layer 298, indexed by Node ID. Manage Route Table use case 315 provides the capability to manage a route table containing routes on the routing engine layer 298. Manage Route Table use case 315 is invoked when route table is accessed. Log routing engine use case 320 begins when user actor 305 chooses to enable logging of the routing engine layer 298. Log routing engine use case 320 ends when routing engine layer 298 is stopped or user actor chooses to disable logging of routing engine layer 298. Log routing engine use case 320 is involved with one activity, namely start/stop logging routing engine use case 325. Start/stop routing engine use case 325 begins when the routing engine layer 298 starts/stops.

Process Routing Message use case 330 begins when transport actor 310 receives a routing message (i.e. a data message containing routing information or a routing request) and asks the routing engine layer 298 to process it. Process Routing Message use case 330 ends when the routing message is processed with or without success. Transport actor 310, specifically transport wrapper layer 140 receives a routing message on a pre-defined port of CD 50 and invokes routing engine layer 298 to process the routing message. Routing engine layer 298 parses the routing message and determines what to do based on the routing message type.

Maintain Local Connectivity use case 335 begins when the routing engine layer 298 receives a hello message or it is the time to maintain connectivity status to neighbor nodes 15. Maintain Local Connectivity use case 298 ends when the operation completes with or without success. The activities involved in Maintain Local Connectivity use case 335 are: broadcast hello message, process hello message, maintain local connectivity, update blacklist. Routing engine layer 298 on any given node 15 maintains the connectivity to active neighbor nodes 15 (i.e. those remote neighbor nodes 15 that have been transmitting messages to given local node 15). If routing engine layer 298 on local node 15 does not receive any packets (messages) from a remote neighbor node 15, local node 15 assumes that the (physical) link to remote neighbor node 15 from which packets were not received is lost. Routing engine layer 298 on local node 15 will first try to repair the affected routes by starting the Discover Route use case 340. If Discover Route use case 340 fails, routing engine layer 298 on local node 15 will broadcast a route error message by starting the Handle Route Error use case 345.

Handle route error use case 345 begins when a route error condition arises. Handle route error use case 345 begins when the route error is handled. The activities involved in handle route error use case are: handle broken link, handle unreachable destination, and process route error message.

Discover route use case 340 begins when transport actor 310 needs to find a new route to a given destination node 25 or the existing route is invalid. Discover route use case 340 ends when the operation is completed with or without success. The activities involved in discover route case 340 are discover route use case 340 and repair broken route use case 350. The routing engine layer 298 first tries to find a valid route to the given destination node 15 from the routing table. If a route to destination node 15 is found, discover route use case 340 ends. Otherwise, routing engine layer 298 on (local) node 15 tries to build a route request and broadcasts the request to other nodes 15. Routing engine layer 298 then waits for the corresponding route reply and uses the reply to create or update the route entry in the route table. If the routing engine layer 298 does not receive the route reply within certain period of time, it tries to re-broadcast a new route request. Routing engine layer 298 on node 15 repeats the re-broadcast until routing engine 298 gives up. Repair broken route use case 350 is invoked when a destination node 15 is unreachable due to a broken link to the next node 15 on the route (in the routing table) to destination node 15 or a route error condition occur for some other reason. Routing engine layer 298 then attempts to repair the affected route. Repair Broken Route use case 350 ends when the route repair is completed with or without success. A special route discovery activity occurs when a broken route is being repaired.

Process Route Request use case 355 begins when the routing engine layer receives a route request. Process Route Request use case 355 ends when the route request is processed with or without success. The activities involved in Process Route Request use case 355 are drop route request, forward route request, and generate route reply.

Process Route Reply use case 360 begins when routing engine layer 298 receives a route request reply. Process Route Reply use case 298 ends when the route reply is processed with or without success. The activities associated with Process Route Reply use case 360 are update route and forward route reply.

Process Route Error Message use case 365 begins when routing engine layer 298 receives a route error message. Process Route Error Message use case 365 ends when the route error is processed with or without success.

Control Route Request Dissemination use case 370 begins when routing engine layer 298 needs to broadcast a route request. Control Route Request Dissemination use case 370 controls the amount of network traffic caused by route discovery messages. Control Route Request Dissemination use case 370 ends when the route request is built for broadcast.

The Update Route to Previous Hop use case 375 begins when the routing engine layer 298 receives a routing message. The Update Route to Previous Hop use case 375 ends when a route is established to the previous node 15, i.e. the previous hop node 15, in the route or the operation fails. The preconditions for Update Route to Previous Hop use case 375 are that transport actor 310 has received a routing message and that link/physical layer 280 supports bi-directional communications. Once transport actor 310 receives a routing message, transport actor 310 invokes the routing engine layer 298 to parse the routing message. Upon successful parsing, the routing engine layer 298 tries to establish a route to the previous hop node 15 where the routing message is from.

Routing and route updates are specific to the actual routing protocol and the details are not known at the generic routing engine abstraction level. In the embodiment, the routing protocol used by routing engine layer 298 may consist of an implementation of Ad hoc On-Demand Distance Vector (AODV) techniques, such as those disclosed by C. Perkins, E. Belding Royer, and S. Das in Request for Comments no. 3561 (Internet Society, July 2003), which is hereby incorporated by reference.

Like many routing techniques AODV makes use of routing metrics. A routing metric is a parameter used by an operating system, network protocol or routing mechanism, such as routing engine 298 to gain knowledge about the efficiency of a particular route. Given the importance of position information in the embodiment, and for ad hoc wireless networks in general, routing engine layer 298 could use a routing metric based on local node 15 and remote node 15 position information. Under such an approach, position information consisting of, but not limited to, the precise latitude, longitude, altitude, velocity, course, time, and magnetic variation of each node 15 is circulated regularly throughout the network. When source node 15 requires a route to destination node 15, or must decide between multiple routes, the three dimensional positions of each potential hop node 15 can be used to establish a metric for all possible routes between source node 15 and destination node 15. The latitudes, longitudes, and altitudes making up the three dimensional positions can be used to calculate the three dimensional straight line distances between each hop node 15 or potential hop node 15 in a route, and assign a metric that reflects the reliability of the wireless link at this distance.

There are variety of ways a three-dimensional position based routing metric could be used by routing engine 298 for determining routes. For example, below some distance threshold where link/physical layer 280 link reliability for transmission or reception is fairly high, the routing metric for each hop node 15 or potential hop node 15 might increase linearly with distance whereas, above the threshold, the routing metric might increase exponentially to reflect the effect of far-field signal degradation on link/physical layer 280 link performance. Alternatively, latitude and longitude could be used to calculate the 2 dimensional above ground distance between hop nodes 15 or potential hop nodes 15, to form a coordinate set with the difference in altitude between nodes 15. These coordinates could be checked against the E plane and H plane signal distributions of the transmitter/receiver pairing between nodes 10. Coordinates well inside the signal distribution range would generate favorable routing metrics, with smaller values being considered better, that would favour use of a node 15 as a hop node 15 for multi-hopping along a route from source node 15 to destination node 15. The value of routing metric would increase linearly as the coordinates approach a spatial distribution threshold, and then increase exponentially outside the threshold.

In addition to locations of nodes 15, velocities of nodes 15 might also be used, either on a stand-alone basis or in combination with location information, to establish routing metrics. Similar to the location based routing metric processes described above, the relative velocities of potential hop nodes 15 could be calculated and a metric assigned that reflects the expected reliability of link/physical layer 280 transmission of messages using between the potential hop nodes 15. The routing metric could reflect the Doppler effects between nodes 15 given their relative velocities and communication frequencies, and/or known or measured relative velocities that provide good/poor link performance for link/physical layer 280 transmission of messages.

In addition to the question of routing using metrics, in mobile ad hoc networks it is not uncommon for node 15 to move outside the communication range 20 of other nodes 15. When this occurs, node 15 will lose communication with other nodes 15, including any nodes 15 that node 15 was communicating with by routing through these other nodes 15, as hop nodes 15, and vice versa. Instead of waiting for this loss of communication to happen, core engine layer 285 for the embodiment may make use of a scheme where position and Geographic Information System (GIS) information is used to predict this loss of communication and take action to search for new routes and hand-off existing routes in such a way as to minimize interruptions to traffic. This predictive algorithm would use the precise location information, velocity, course and other position information of all relevant nodes 15 to determine when a particular node 15 is likely to lose a communication point in the network 10. As this probability increases, the routing metric for all routes involving the particular node 15 of concern would increase. At some threshold, routing engine layer 298 would react by looking for replacement routes but without halting communication. If routes with a more favorable metric are discovered, traffic will be re-routed.

The use of position based routing metrics can also be used to reduce the negative impact of the doppler shift on communication between nodes 25. The Doppler shift is equal to the relative velocity of a transmitter of a signal, such as link/physical layer 280 on a node 15 transmitting messages, with respect to the receiver of a signal, such as link/physical layer 280 on node 15 receiving the message, divided by the wavelength of the signal, multiplied by the cosine of the spatial angle between the direction of motion of the receiver and the direction of arrival of the signal. The maximum spreading will occur when the angle is zero. This happens when the devices are moving directly towards or away from each other.

By using the position based routing metrics, the (AODV) algorithm can effectively attenuate Doppler effects by setting a multi-hop route to use an intermediary negotiating node 15, not collinear with the other hop nodes 15, to mediate communications. Intermediary node 15 would thus have lower Doppler shift and not be affected to the extent of two nodes 15 directly flying towards one another.

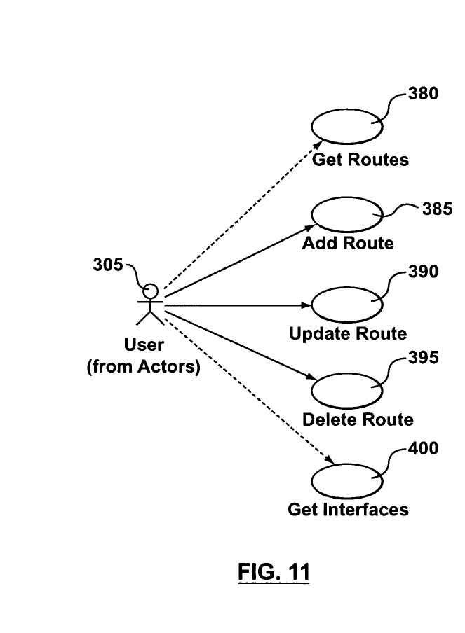

Turning now to FIG. 11, therein is shown a UML use case diagram for the Network Wrapper layer 295. As shown in FIG. 20, the operation of the Network Wrapper layer 295 includes: Get Routes use case 380, Add Route use case 385, Update Route use case 390, Delete Route use case 395 and Get Interfaces use case 400. Network wrapper layer 295 is invoked in response to requests by User actor 305 which is a human user or an external system.

Get Routes use case 380 is invoked when user actor 305 chooses to get route entries from the route table on local node 15 for a given destination node 15, including any corresponding gateway and interface. Add Route use case 385 is started when User actor 305 chooses to add a route entry to the route table on local node 15 for a given destination node 15, including any corresponding gateway and interface. Update Route use case 390 is started when the User actor 305 chooses to update a route entry, such as any gateway and interface, for a node 15 in the route table. Delete route use case 395 is started when the User actor 305 chooses to delete a route entry from the route table on local node 15. Get Interfaces use case is started when the User actor 305 chooses to get all the network interfaces on the operating system on local node 15.

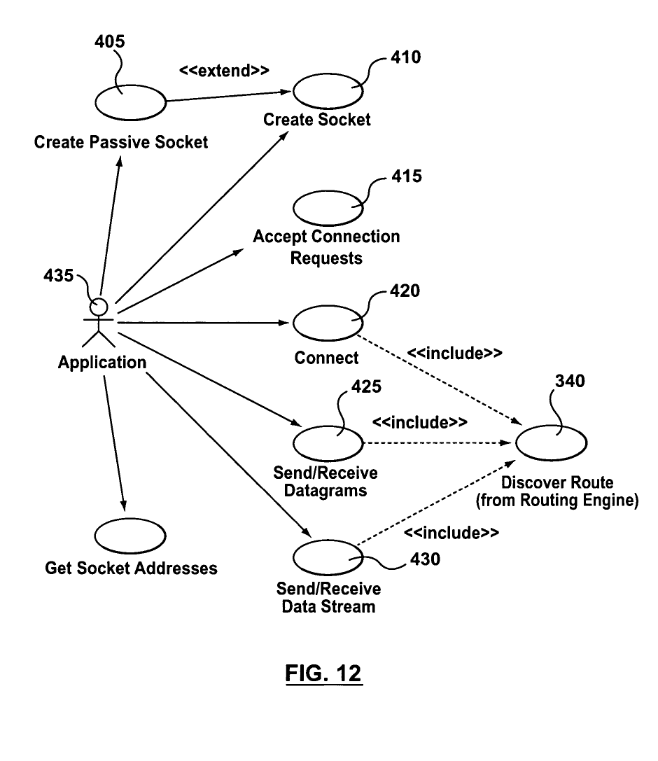

FIG. 12 is a UML use case diagram for transport wrapper layer 140 for the embodiment. The operation of the Transport Wrapper layer 140 includes: Create passive socket use case 405, Create socket use case 410, Accept connection requests use case 415, Connect use case 420, Send/Receive datagrams use case 425, Send/Receive stream data use case 430. Transport wrapper layer 140 passes the data in these use cases to network layer 290 for transmission over the network 10 using link/physical layer 280. The transport wrapper layer 140 is invoked by application actor 435, which corresponds to application 95 and which makes use of platform layer 85 functionality via API layer 90.

A socket is a TCP/IP address which provides addressing to particular devices on the network 10. Create Passive Socket use case 405 is invoked to create a passive socket for connecting to services offered by a device on a node 15. Create Socket use case 410 is invoked to create a generic socket for a communication end point, such as a destination node 15. Two types of sockets can be created, namely stream and datagram sockets. Accept Connection Requests use case 415 is started to accept connection requests. Connect use case 420 is started to connect to a known communication port on a specified host (node 145). Send/Receive Datagrams use case 425 is started to send and receive datagrams using datagram sockets. A datagram contains information about network 10 and nodes 15 as well as type of application 95. Send/Receive Stream Data use case 430 is started to send or receive stream data over a connection oriented TCP connection.

The embodiments shown in FIGS. 6 and 7 may be advantageously used to implement a number of applications 95, using API layer 90, that may involve aircraft nodes 95. Further, since API layer 90 and platform layer 85 are independent of lower layers, such as device layer and core engine layer in all embodiments, an application 95 may be implemented using a variety of different wireless transceivers 60 and sensors 65.

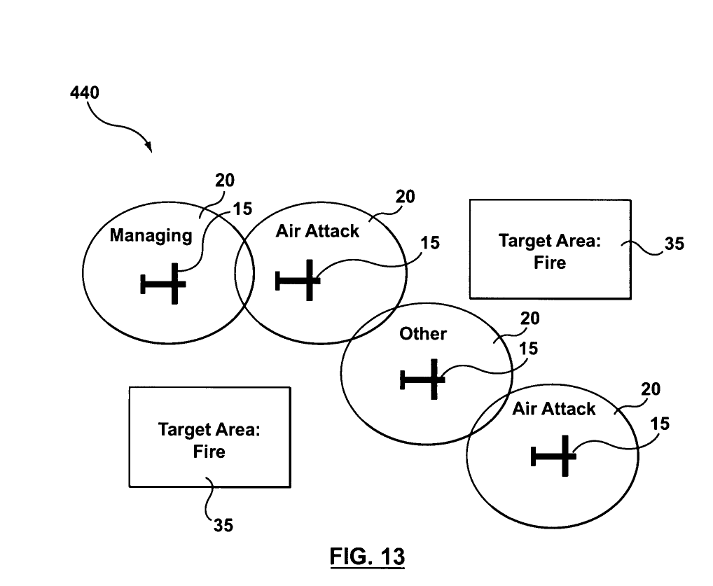

Turning now to FIG. 13, therein is shown a block diagram of a fire fighting application 440 for fighting fires that advantageously makes use of the present invention. The system comprises a series of nodes 15, some of which are aircraft nodes 15, that are used for fighting fires. Each node 15, whether aircraft, ground vehicle, or stationary object, has a TD 40 with fire fighting application 440 running. Fire fighting application 440 is implemented as application 95 using API layer 90 and uses positioning data from positioning layer 205, i.e. GPS transceiver. Thus, Fire fighting application 440 is well suited for use on either the architecture 195 of the second embodiment or architecture 200 of third embodiment.

Fire fighting application system 440 has a number of air attack nodes 15 that are located on air attack aircraft. Air attack nodes 15 are used for dispensing fire fighting substances. Fire fighting application 440 may be used to designate target area 35 in which a task is to be carried out. Such a task may comprise deploying fire fighting substances in target area 35, notably by air attack nodes 15 when target area 35 contains a fire. A task may also consist of navigating to a target area 35 and or surveying target area 35. Generally, tasks are assigned by one or more managing nodes 15, often located on an aircraft referred to as a bird dog in fire fighting activities. Managing nodes 15 manage air attack nodes 15 and nodes 15 in other vehicles.

For fire fighting application 440, the software is the same on all nodes 15 and consists of an application 95 that makes use of API layer 90 to invoke services from platform layer 85. On each node 15, CD 50 displays information relating to position, speed, and direction of all nodes 15, including node 15 on which CD 50 is located. CD 50 also displays and provides navigational information and directions to target area 35 for CDs 50 on air attack node 15 to which a task has been assigned for target area 35 by managing node 15. In addition, CD 50 on air attack node 15 provides assistance to air attack node 15 for carrying out task in target area 35, such as displaying information on when and where to deploy fire fighting substances. CD 50 on all nodes 15 can view status of air attack node 15 assigned a task for target area 35 for completing task and navigating to target area 35. Additionally CD 50 can display status of attack node 15, speed, position, direction, navigational information and directions for all nodes 15 on a view providing a geographical map generated from the GIS database in conjunction with use of positional data from positioning layer 205.

Generation of positional information, navigation information, speed, direction, navigation instructions, and map views is made possible by using data provided by positioning layer 205, i.e. GPS transceiver, on nodes 15. Positioning layer 205 on a given node 15 regularly receives position data for the given node 15 from a satellite or the like. In addition, each node 15 receives position data from all other nodes 15 over link/physical layer 265 when implemented on second embodiment or link/physical layer 280 when implemented on third embodiment. Position data from other nodes 15 is routed from core engine layer 270 of second embodiment or core engine layer 280 of third embodiment to network manager 135. Position data from local node 15 is routed to position support layer 210.

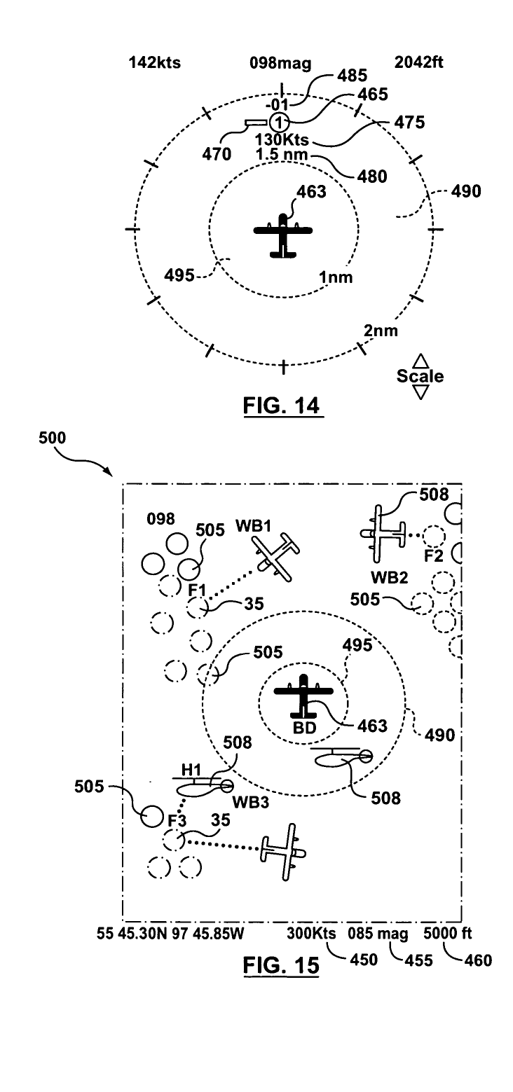

Network manager 135 and positioning support layer 210 then send position data to position services layer 215. Position services layer 215 then uses position information received to calculate speed, direction, navigation information and navigation instructions, by comparing previously received position information with new position information and performing calculations to derive speed, direction, navigation information and navigation instructions. To provide map views, position services layer 215 cross references position information received and results of calculations with data in the GIS database. The exact information generated by position services layer 215 depends on instructions transmitted from fire fighting application 440, as an application 95, to position services layer 215 using API layer 90. Results of calculation and all information required for Fire fighting application 440 are also transmitted from positioning services layer 215 to fire fighting application 440 using API layer 90. To further aid the reader in understanding Fire fighting application 440 and the utility of information provided, reference is now made to FIG. 14 to FIG. 17 (inclusive). FIG. 14 to FIG. 18 provide a number of views of graphical user interfaces (GUI) generated by Fire fighting application 440 and displayed on CD 50. In general, for GUIs, distance is expressed in nautical miles (nm), speed is expressed in knots (kts), and altitude is expressed in (ft). However, other units for any of these measures may be used. It is not the intention of the inventors to restrict information provided or displayed by the present invention to a fixed set of units of measure

FIG. 14 shows an example of a Traffic View GUI 445 provided by Fire Fighting application 440. Traffic View GUI 445 shows location data of local node 15, whether aircraft node 15, ground vehicle node 15 or another type of node 15, and remote nodes 15 in the network 20. For local node 15, local node speed 450, local node magnetic course 455, and local node altitude 460 are shown. Local node 15 is itself shown at center of Traffic view GUI 445 as a local node icon 463. Other information may also be shown, such as status of radio communication for local node 15 or position of local node geographic coordinates in Latitude/Longitude or Universal Transverse Mercator, may also be shown.

Remote node 15 is shown as a circular dot 465. Remote node magnetic course 470 is shown as a line pointing in direction of movement, originating at the dot representing the node 15. Remote node speed 475, relative remote node distance 480, and relative remote node altitude 485 compared to local node are also shown.

Traffic view GUI 445 also displays two distance rings, outer distance ring 490 and inner distance ring 495, around local node icon 463 that represent distance from local node 15 of remote nodes 15. Radius of outer distance ring 490 is twice radius of inner distance ring 495 radius. Scale and distance represented by outer distance ring 490 and inner distance ring 495 are adjustable by user. If a remote node 15 moves off the screen of Traffic view GUI 445, the user is warned and is invited to adjust the scale to make remote node 15 visible again.

Traffic view GUI 445 allows users to see speed, navigational, and positional information about local node 15, as well as relative distance and directional information for remote nodes. Thus, traffic view GUI 445 is useful for quickly obtaining information about all nodes 15 and their relative positions and courses. Such information may be used for avoiding collisions and assigning tasks to nodes 15

FIG. 15 shows an example of an Operational View GUI 500 provided by Fire Fighting application 500. Operational View GUI 500 shows location and identity of nodes, as well as target areas 35 which may represent fires 505. More specifically, operational view GUI 500 provides operational information. Each node 15 is described on screen by a moving icon 508, including local node icon 463, specific to the type of aircraft. Absolute or relative altitudes for each node 15 are also shown as well as visual proximity to target areas 35. Local node's 15 geographic coordinates, local node's speed 450, local nodes magnetic course 455, and altitude 460 are also displayed. Inner distance ring 495 and outer distance ring 490 are displayed around the local node icon 15. The status of each node 15 in the Operational view GUI 500 can describe such things as presence of fire fighting payload, fuel, or other information is also communicated between nodes 15 and may be displayed.

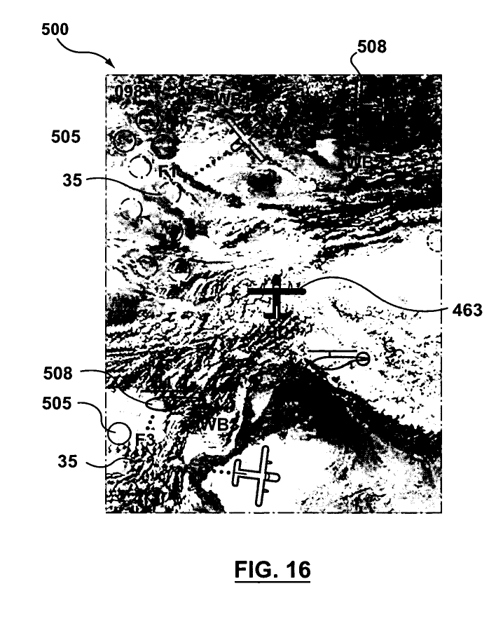

FIG. 16 is an example of operational View GUI 500 of FIG. 15 with mapping information displayed. Operational View GUI 500 allows the user to import mapping information that is displayed as a map 510 in the background. Map 510 may give the user topographical information about the region and provide visual cues for the operating area, Mapping information can also provide text labels and descriptions of topographic features. The mapping information can be incorporated into the system in a GIS compatible format such as a shape file, database file or other, or could be drawn from other maps sources including but not limited to bitmaps, and geo-referenced images and documents. Alternatively, map 510 may show infrared data to better display intensity of fires. Map 510 may also show other data to assist in visualization from an operational perspective. Mapping images and GIS data are provided or generated from information furnished by 215 positioning services layer 215 to fire fighting application 445 via API layer 95. It is not the intention of the inventors to limit information displayed on map 510 to infrared or topographical data. The Operational View GUI 500 allows for rotation of map in real-time to keeping local node icon 463 orientation constantly pointed towards the top of the display screen. Alternatively, map can be held fixed on the screen and the local node icon 463 may move around the screen describing accurately its motion.

Operational View GUI 500 can also display fire fighting operational information alongside the topographic information when mapping information is displayed. Fire fighting information such as, but not limited to, base camps, fuel cashes, helipads, airstrips, filling stations, ground crew, and other can be displayed over the moving map. Fire fighting information can also be marked in real-time by a node 15 and is instantly displayed on screen. This information is communicated over the network 10 to all other nodes 15 where it is displayed, logged and tracked.

Operational View GUI 505 is interactive and allows firefighters to note and map new fire locations, including the perimeter of fire areas, which may be designated as target areas and shown on operational view with or without mapping data. Further, one mapped as a fire area by an aircraft or other node using fire fighting application, information on fires status will be updates at least once per day. However, users of fire fighting application 440 may also survey status of fires without waiting for daily updates and by using (P2P) data sharing abilities, will instantly be able to update other nodes about fire status or be so updated by other nodes. from ex available at least be available at least once Operational View GUI 505 also allows managing node 15 to assign tasks for target areas 35, and notably to direct nodes 15 to target areas for deploying fire fighting substances. Operational view GUI 505 thus allows users on all nodes to visually perceive relative position and course of all other nodes 15 and target areas 35, as well as to see assigned tasks for all nodes 15. As such, Operational view GUI 500 thus allows users to quickly evaluate use of resources for fighting fires. Further, operational view GUI 505 also allows users on a managing node 15 to quickly make decisions about the quantity of resources, such as number of attack nodes 15, that should be allocated to a task.

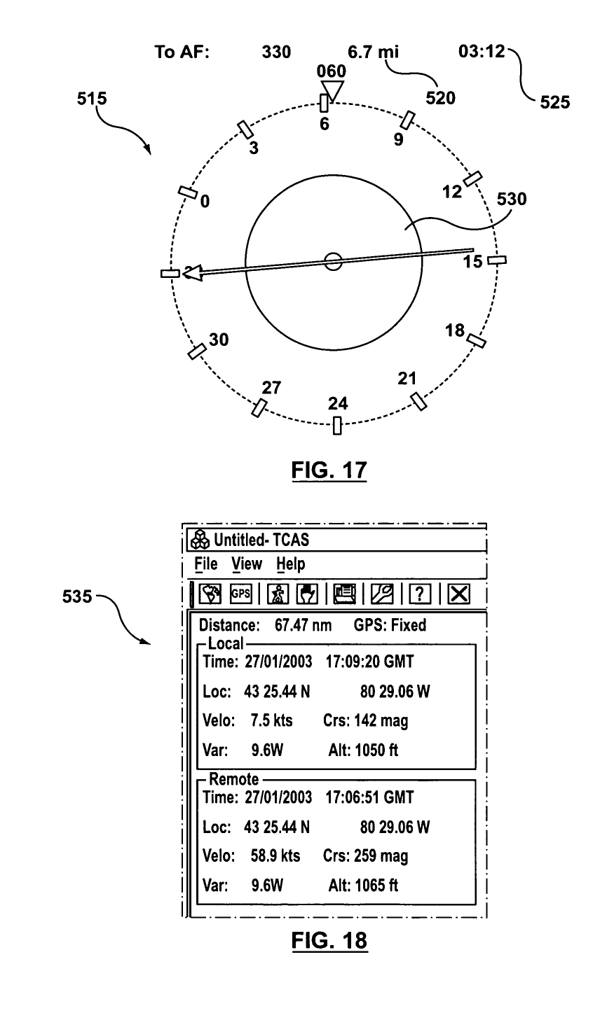

FIG. 17 is an example of an instrument view GUI 515 on an attack node 15, which provides further information on position of air attack node 15 with regard to target area for deploying fire fighting material. Instrument view GUI 515 may indicate estimated distance 520 from target area 35, estimated time 525 to target area, and bearing of node 15. Center circle 530 of instrument view GUI is color encoded to show location of air attack node 15 in terms of four zones. Don't drop zone indicates an area within which fire fighting substances must not be deployed. Final approach zone indicates an area in which users on air attack node 15 assigned task of deploying fire fighting substances should commence final approach to target area 35. Get ready zone is the area in which user on air attack node 15 should prepare airborne vehicle to deploy fire fighting substance. Drop location is the area in which attack node 15 must deploy fire fighting substances, i.e. in target area 35. Colour of center circle 530 changes according the four zones described, thus assisting user in preparation for deployment. It will be apparent to one skilled in the art that instrument view user interface GUI 515 could be adapted for other tasks involving aircraft vehicles using geographical information, such as crop dusting and military applications, among others.

FIG. 18 is an example of a text view GUI provided by fire fighting application 535. Text view GUI 535 may show data for both local node 15 and remote nodes 15 in a textual format. For both local node 15 and remote node 15, the data may include, among other things: location of node 15, velocity of node 15, course of node 15, altitude of node 15. In addition to the embodiments and fire fighting application described above, there are a large number of alternative embodiments and applications for which the present invention may be used. In general, provided an appropriate sensor 65 for an application 95 is present with an appropriate WCT 60, the present invention can be used to provide a peer to peer ad hoc wireless network 10 for communicating and sharing data for the application 95. Further, since sensor 65 and WCT 60 are hidden from platform layer 85 and API layer 90, applications 95 can be developed without changing existing platform layer 85 and API layer 90. Some possible alternative embodiments and applications 95 that may be implemented using the present invention are described below.

Coordination of Emergency Vehicles

In this embodiment ambulances and fire engines form a mobile ad hoc network 10 for aiding in emergency situations. The display in this embodiment shows other emergency vehicles at the emergency scene and transmits positional and other data to coordinate rescue efforts. This application 95 could be implemented using either of the embodiments shown in FIG. 6 or FIG. 7 and would require a sensor 65 having positional capability.

Police Patrols

An embodiment of the present invention could also be used to coordinate police work such as coordinated chases or the like. In this case police vehicles may communicate data between all vehicles involved, and transmit positional information. Network 10 transmits data securely so that a criminal element may not intercept sensitive data. Again, this application 95 could be implemented using either of the embodiments shown in FIG. 6 or FIG. 7, or any other embodiment provided that an appropriate sensor 65 with positional capability.

Intelligent Sensor Networks

Alternately an embodiment of the present invention may be used to create an embodiment having an intelligent ad hoc mobile sensor network. In this case, each node has a sensor 65, perhaps other than sensor 65 for positioning, that gathers information necessary for the specific application 95 implemented on architecture provided by embodiment. This information can then be shared among all nodes 15 in network 10. For example, bar code readers could be used to read bar codes on boxes to evaluate and store warehouse contents or truck load contents. This information can then be wirelessly shared, on a mobile basis, amongst nodes 10.

Transportation Tracking

An embodiment of the present invention may be used in transportation to track location and load contents of land vehicles, such as trains, cars, or trucks. The devices in this case transmit data such as text, voice, and contents tracking information including but not limited to vehicle contents, weight, disposition, destination location. An application 95 in this area might involve an embodiment having a bar code reader, mass detector, and GPS as sensors 65.

Disaster Recovery

An embodiment of the present invention could also be used to quickly set up networked communication in areas where natural disasters, physical disasters, or other have rendered existing network infrastructure inoperable. This could involve using the self-forming network capabilities of the ad hoc wireless network provided by present invention to enable the exchange of data, positional information, instrument or sensor data, voice, video or other data in a time critical environment. Once again, this would require appropriate sensors 65 and support at the core engine layer to support application 95.

Search and Rescue

An embodiment of the present invention may also be used in search and rescue operations to allow the sharing of information between ground stations, vehicles, or patrols, airborne vehicles, and marine vessels. The nodes 15 installed on vehicles could allow rescue teams to coordinate efforts by sharing precise positional information in real-time. The nodes 15 could also allow for digital marking of searched and un-searched locations, geographic and topological referencing, assignment of targets and tasks, and data logging. The nodes 15 could further allow the input and sharing of user defined areas such as avalanche zones, flood regions, infrastructure collapse, etc. Since such use of an embodiment of the present invention would rely principally on positional data, applications appropriate for search and rescue could be implemented on the embodiments similar to those shown in FIGS. 6 and 7.

Public Transit

An embodiment of the invention may also be used in public transportation systems to report positional and kinematics information. Nodes 15 would allow public transit vehicles housing nodes 15 to report positional and prospective arrival times to destinations and stops. Nodes 15 could also allow sharing of traffic information, road conditions, and connection information between vehicles. Since such use of an embodiment of the present invention would rely principally on positional data, applications appropriate for search and rescue could be implemented on the embodiments similar to those shown in FIGS. 6 and 7.

Surveying and Remote Region Communications

An embodiment of the present invention could additionally be used in land based; air to land or air based geographical surveying or other remote location work where communication is required. Nodes 15 would allow the sharing and marking of geographic location, exchange of sensor information, data and voice communication, and could be used to coordinate team positions and tasks. Since such use of the present invention would rely principally on positional data, applications appropriate for search and rescue could be implemented on the embodiments similar to those shown in FIGS. 6 and 7.

Hospital Patient Tracking

An embodiment of the present invention could also be used advantageously to track the precise location of individuals within a particular institution or area. One application for nodes 15 would be the tracking of patients while in hospital. The device would relay position and patient information to hospital staff, while allowing 2 way messaging and other forms of data exchange.

Armed Forces Communications

An embodiment of the invention may also be used to provide all forms of information sharing between armed forces teams in an ad hoc environment. For example, nodes 15 could be used by supply teams to exchange positional information of resources.

The present invention provides a network for sharing data among airborne vehicles that is self-forming, self-healing, reliable, tolerant of failure, and capable of updating time sensitive information in real time. The network also implements multi-hopping, whereby a device in the network may forward data between other devices that may not be in range of one another, to maximize the distance over which two computing devices on different airborne vehicles can communicate. Thus, the present invention allows for sharing of information on computing devices on airborne vehicles for real-time, high speed operations, such as fire fighting, carried out by mobile teams in airborne vehicles.

It will be apparent to one skilled in the art that other embodiments using different kinds of sensors and wireless communication devices may be possible. Further, many types of applications for various embodiments will also be possible. It is not the intention of the inventor to limit the scope of the invention to the specific embodiments or applications disclosed herein. The embodiments and applications described herein are disclosed for purposes of example and not limitation.

1. A wireless communications system for communicating a data message comprising:
a wireless data communication network for transmitting and receiving the data message;
a source computing device, connected to said wireless data communication network, for generating the data message;
a plurality of receiving computing devices connected to said wireless data communication network, said plurality of receiving computing devices further comprising a destination computing device, for receiving and further transmitting the data message until said destination computing device receives the data message; and
software on each source and receiving computing device for managing the data message and said transmitting and said receiving; wherein at least two of said source computing device and said receiving computing devices are installed on vehicles, at least one of said vehicles being an airborne vehicle.

2. The system of claim 1, wherein said wireless data communication network comprises a plurality of 900 MhZ transceivers, at least one of said transceivers being installed in each of said vehicles, for broadcasting and receiving said data message using frequency hopped-time division multiplex access, said source computing device and each receiving computing device being connected to at least one of said 900 MhZ transceivers.

3. The system of claim 1, wherein said wireless communication network comprises a plurality of transceivers, at least one of said transceivers being installed in each of said vehicles, for broadcasting and receiving said data using the 802.11b protocol, said source computing device and each receiving computing device being connected to at least one of said transceivers.

4. The system of claim 1 further comprising a plurality of global positioning system transceivers wherein:
each vehicle has at least one of said global positioning receivers installed; and
said source computing device and each receiving computing device is connected to one of said global positioning system transceivers.

5. The system of claim 4 wherein the data message further comprises
geographical navigation data and geographical positional data for at least one of said vehicles provided by at least one of said geographical positioning system transceivers, said geographical navigation data and geographical positional data being graphically displayed on at least one of said source computing device or said plurality of receiving computing devices at the request of a user.

6. The system of claim 5 wherein the data message further comprises target geographical navigational and target geographical positional data for at least one of said vehicles with regard to at least one target area where said at least one of said vehicles is a task vehicle designated to complete a task.

7. The system of claim 6 wherein,
at least one of said vehicles is a managing vehicle designated for managing at least one other vehicle; and
said computing device on said managing vehicle may designate said at least one target area, said task, and said task vehicle for proceeding to said at least one target area for completing said task.

8. The system of claim 7 wherein
said vehicles are used for fighting a fire;
the data message further comprises data about said fire; and
said source computing device and said receiving computing devices provide said geographical navigational information and said geographical positional information with regard to each of said vehicles as well as said target geographical positional navigational and said target geographical positional information for said at least one target area for deploying fire fighting substances, as well as instructions for deploying said fire-fighting substances.

9. The system of claim 8 wherein said target geographical positional information and said target geographical navigational information and said geographical navigation data and geographical positional data for said vehicles is provided using a graphical user interface on said sending computing device or said receiving computing devices, said interface displaying the position, speed, and direction of each of said vehicles, said at least one target area, said instructions for deploying said fire-fighting substances, and directions for navigating to said target areas.

10. The system of claim 9, wherein said interface further displays on a map representing the geographical area in which said vehicles and said at least one target area located.

11. The system of claim 1, wherein said software comprises:
a device layer providing an interface for physically transmitting and receiving the data message over said wireless data communications network;
an application programming interface layer for providing an interface for applications on said computing device that use said data;
a platform layer that manages communication of the data message on said network in accordance with instructions received from said applications using said application programming interface and provides the data message to said applications using said application programming interface; and
a core engine layer that provides for transmission and reception of the data message from said source computing device and said receiving computing devices over said wireless data communication network using said device layer, including said further transmitting of the data message, in accordance with instructions received from said platform layer.

12. A method for wireless data communication of a data message comprising:
generating the data message on a source computing device connected to a wireless data communication network comprising a plurality of wireless data transceivers installed at least on a plurality of vehicles;
transmitting the data message on said wireless data communication network to at least one receiving device from a plurality of receiving computing devices connected to said wireless data communication network;
receiving the data message on said at least one receiving computing device; and
unless said at least one receiving computing devices is a destination computing device for the data message, further transmitting the data message from said at least one receiving device to at least one other receiving computing device until said destination computing device receives the data message, wherein at least two computing devices among said source computing device and said receiving computing devices are installed on said vehicles, at least one of said vehicles being an airborne vehicle.

13. The method of claim 12, further comprising:
generating, as part of the data message, geographical positional information and geographical navigational information for at least one of said vehicles from a geographical positioning system transceiver installed on each of said vehicles and connected to said source computing device or one of said receiving computing devices; and
graphically displaying said geographical positional information and said geographical navigational information on said source computing device or said at least one of said receiving computing devices.

14. The method of claim 13, further comprising:
designating a target area where at least one of said vehicles is to complete a task;
using said geographical position system transceivers to include target geographical navigational and target geographical positional data for said at least one of said vehicles with regard to said at least one target area.

15. The method of claim 14 further comprising:
designating at least one of said vehicles as a managing vehicle for managing at least one other vehicle using the source computing device or receiving computing device on said managing vehicle as a managing computing device for said managing; and
designating said at least one target area, said task, and a vehicle as a task vehicle for proceeding to said target area for completing said task with said managing computing device.

16. The method of claim 15 wherein:
said vehicles are used for fighting fires;
said at least one target area comprises an area for fighting fires; and
said task comprises deploying fire fighting substances.

17. The method of claim 16 wherein said providing said geographical navigational information and said geographical positional information comprises:
providing said geographical navigational information and said geographical positional information with regard to each of said vehicles;
providing said target geographical navigational information and said target geographical positional information with regard to said at least one target areas for fighting fires; and
providing instructions for deploying said fire-fighting substances.

18. The method of claim 17 further comprising displaying said geographical positional information, said geographical navigational information, said target geographical positional information and said target geographical navigational information on a graphical user interface on said sending computing device or said receiving computing devices, said graphical user interface allowing a user to view on request:
the position, speed, and direction of each of said vehicles;
said at least one target area;
said instructions for deploying said fire-fighting substances; and
directions for navigating to said target areas.

19. The system of claim 18, further comprising displaying on said geographical user interface a map representing the geographical area in which said vehicles and said at least one target area are located.

20. A networking system for collaboration among a plurality of aircraft, said networking system comprising:
a sensor provided to each of said plurality of aircraft; and
a terminal device provided to each of said plurality of aircraft, said terminal device comprising:
a wireless communication device for communicating with wireless communication devices and terminal devices on others of said plurality of aircraft to form an ad hoc wireless network when in communication range;
a computing device in communication with said wireless communication device and said sensor, said computing device comprising:
means for receiving information from said sensor;
means for communicating said sensor information to computing devices on others of said plurality of aircraft via said ad hoc wireless network and for receiving said sensor information from computing devices on others of said plurality of aircraft via said ad hoc wireless network; and
a graphical user interface (GUI) for displaying sensor information received from said sensor and received from computing devices on others of said plurality of aircraft.

21. The networking system of claim 20, wherein said means for communicating comprises means for routing information through said ad hoc wireless network.

22. The networking system of claim 21, wherein said means for routing information manages information flow such that information from a sender may pass through one or more terminal devices before reaching a destination.

23. The networking system of claim 21, wherein said means for routing information detects when a terminal device is no longer available in the ad hoc network and re-routes information accordingly.

24. The networking system of claim 20, wherein said sensor is a global positioning system (GPS) sensor and said sensor information is GPS information.

25. The networking system of claim 24, wherein said computing device further comprises means for displaying map information on said GUI underlying said displayed GPS information such that a position of one or more of said plurality of aircraft are shown in relation to said map information in real-time.

26. The networking system of claim 25, wherein said map information comprises geographical information system (GIS) information.

27. The networking system of claim 25, wherein said computing device further comprises a user input system allowing a user of said computing device to input information for communication through said ad hoc network for display on one or more GUIs.

28. The networking system of claim 27, wherein said user input information comprises information regarding an event of interest observed visually by said user.

29. The networking system of claim 28, wherein said event of interest comprises a forest fire and said user input information comprises information regarding said forest fire perimeter.

30. The networking system of claim 28, wherein said event of interest comprises a target, an approach line for said target, and an aircraft assigned to said target.

31. The networking system of claim 20, wherein said sensor comprises a plurality of sensors and said sensor data from said plurality of sensors is selectively displayed on said GUI depending on a predetermined view or on a user request.

32. The networking system of claim 31, wherein said plurality of sensors comprise sensors for air speed, direction, position, and fire-retardant tank fill level.

33. The networking system of claim 20, further comprising one or more land-based units, each said land-based unit comprising a terminal device and a sensor.

34. A terminal device for an ad hoc network for use with aircraft, said terminal device comprising:
a sensor; and
a wireless communication device for communicating with wireless communication devices and terminal devices on other aircraft to form an ad hoc wireless network when in communication range;
a computing device in communication with said wireless communication device and said sensor, said computing device comprising:
means for receiving information from said sensor,
means for communicating said sensor information to computing devices on said other aircraft via said ad hoc wireless network and for receiving said sensor information from computing devices on said other aircraft via said ad hoc wireless network; and
a graphical user interface (GUI) for displaying sensor information received from said sensor and received from computing devices on said other aircraft.

35. The terminal device of claim 34, wherein said computing device further comprises means for routing information through said ad hoc wireless network.

36. The terminal device of claim 35, wherein said means for routing information manages information flow such that information from a sender may pass through one or more terminal devices before reaching a destination.

37. The terminal device of claim 35, wherein said means for routing information detects when a terminal device is no longer available in the ad hoc network and re-routes information accordingly.

38. The terminal device of claim 34, wherein said sensor is a global positioning system (GPS) sensor and said sensor information is GPS information.

39. The terminal device of claim 38, wherein said computing device further comprises means for displaying map information on said GUI underlying said displayed GPS information such that a position of one or more of said plurality of aircraft are shown in relation to said map information in real-time.

40. The terminal device of claim 39, wherein said map information comprises geographical information system (GIS) information.

41. The terminal device of claim 34, wherein said computing device further comprises a user input system allowing a user of said computing device to input information for communication through said ad hoc network for display on one or more GUIs.

42. The terminal device of claim 41, wherein said user input information comprises information regarding an event of interest observed visually by said user.

43. The terminal device of claim 42, wherein said event of interest comprises a forest fire and said user input information comprises information regarding said forest fire perimeter.

44. The terminal device of claim 42, wherein said event of interest comprises a target, an approach line for said target, and an aircraft assigned to said target.

45. The terminal device of claim 34, wherein said sensor comprises a plurality of sensors and said sensor data from said plurality of sensors is selectively displayed on said GUT depending on a predetermined view or on a user request.

46. A method for collaboration among a plurality of aircraft, said method comprising:
forming an ad hoc wireless network among at least two of said plurality of aircraft when said at least two of said plurality of aircraft are within communication range;
for each aircraft, sensing information related to said each aircraft;
communicating said sensed information to others of said plurality of aircraft via said ad hoc wireless network; and
displaying said sensed information on a graphical user interface (GUI) in each of said plurality of aircraft in real-time.

47. The method of claim 46, further comprising allowing a user of said computing device to input information for communication through said ad hoc network for display on one or more GUIs.

48. The method of claim 47, wherein said user input information comprises a forest fire perimeter.

49. The method of claim 47, wherein said user input information comprises a target, an approach line for said target, and an aircraft assigned to said target.

50. The method of claim 49, further comprising:
alerting said aircraft assigned to said target; and
displaying, in said aircraft assigned, additional instrument guidance information related to said target.

51. The method of claim 50, wherein said instrument guidance information comprises target position, distance and heading to target and estimated time of arrival at target.

52. The method of claim 46, further comprising routing information through said ad hoc wireless network such that information from a sender may pass through one or more terminal devices before reaching a destination and such that, when a terminal device is no longer available in the ad hoc network, information is re-routed accordingly.

53. The method of claim 46, wherein said sensed information is global positioning system (GPS) information and said method further comprises displaying map information on said GUI underlying said displayed GPS information such that a position of one or more of said plurality of aircraft are shown in relation to said map information in real-time.

54. The method of claim 53, wherein said map information comprises geographical information system (GIS) information.

55. The method of claim 46, further comprising selectively displaying said sensor information on said GUI depending on a predetermined view or on a user request.

56. A networking system for collaboration in fighting a forest fire, said networking system comprising:
a terminal device provided to each of a plurality of fire-fighting units, said terminal device comprising:
a global positioning system (GPS) sensor for determining GPS information;
a wireless communication device for communicating with wireless communication devices and terminal devices on others of said plurality of fire-fighting units to form an ad hoc wireless network whenever in communication range;
a computing device in communication with said wireless communication device and said sensor, said computing device comprising:
means for receiving and processing said GPS information from said sensor;
means for communicating said GPS information to computing devices on others of said plurality of fire-fighting units via said ad hoc wireless network and for receiving said GPS information from computing devices on others of said plurality of fire-fighting units via said ad hoc wireless network;
means for generating map information related to said GPS information;
a user input system allowing a user of said computing device to input information for communication through said ad hoc wireless network; and
a graphical user interface (GUI) for displaying said map information, user input information and said GPS information.

57. The networking system of claim 56, wherein said computing device further comprises means for routing information through said ad hoc wireless network.

58. The networking system of claim 57, wherein said means for routing information manages information flow such that information from a sender may pass through one or more terminal devices before reaching a destination.

59. The networking system of claim 57, wherein said means for routing information detects when a terminal device is no longer available in the ad hoc network and re-routes information accordingly.

60. The networking system of claim 56, wherein said map information comprises geographical information system (GIS) information.

61. The networking system of claim 56, wherein said sensor comprises a plurality of sensors and said sensor data from said plurality of sensors is selectively displayed on said GUI depending on a predetermined view or on a user request.

62. The networking system of claim 61, wherein said plurality of sensors comprise sensors for air speed, direction, position, and fire-retardant tank fill level.

63. The networking system of claim 56, wherein said user input information comprises information regarding a perimeter of said forest fire.

64. The networking system of claim 63, wherein said user input comprises said user indicating when said aircraft is at a point above said forest fire perimeter, said computing device recording GPS information as said aircraft traverses said forest fire perimeter, and said user indicating when said aircraft reaches another point above said forest fire perimeter.

65. The networking system of claim 56, wherein said user input information comprises information regarding an event of interest observed visually by said user.

66. The networking system of claim 65, wherein said event of interest comprises a target and said user input information comprises a position of said target, an approach line for said target, and an aircraft assigned to said target.

67. The networking system of claim 66, wherein said aircraft assigned to said target is alerted to said assignment through said ad hoc wireless network and a GUI in said aircraft assigned displays additional instrument guidance information related to said target.

68. The networking system of claim 67, wherein said instrument guidance information comprises target position, distance and heading to target and estimated time of arrival at target.

69. A networking system for collaboration among a plurality of mobile users, said system comprising:
at least one mobile device provided to each mobile user, each mobile device comprising:
a wireless communication device for communicating with wireless communication devices and mobile devices of others of said plurality of mobile users to form an ad hoc wireless network when in communication range;
a sensor;
means for reading information from said sensor;
means for communicating said sensor information to each mobile device in said network; and
means for displaying said sensor information at each said mobile device.

70. The networking system of claim 69 further comprising:
means for displaying geographic information system (GIS) information; and
means for overlaying said GIS information with said sensor information.

71. A method for generating a unique network address in an internet protocol address space for an ad hoc network, said method comprising:
determining a unique media access control (MAC) address of a device to be attached to the network;
determining an index number; and
repeating the following, increasing said index number monotonically, until an IP address that is unique within the ad hoc network is produced:
hashing said MAC address with said index number to generate a trial IP address; and
determining if said trial IP address conflicts with an existing IP address in said ad hoc network.
